(19) United States
(12) Patent Application Publication
(10) Pub. No.: US 2010/0110114 A1
(43) Pub. Date: May 6, 2010

(54) Liquid crystal display device and method of driving thereof

(75) Inventor: Yoshiharu Hashimoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/588,620

(22) Filed: Oct. 21, 2009

(30) Foreign Application Priority Data
Oct. 24, 2008 (JP) 2008-274481

(51) Int. Cl. G09G 5/10; G09G 3/36

(52) U.S. Cl. 345/691; 345/88

(57) ABSTRACT

A liquid crystal display device has: a liquid crystal panel having liquid crystal cells arranged at respective intersections of data lines and scanning lines; and a data line driver circuit. Six kinds of data signals include: a first data signal of positive polarity associated with a first color image data; a second data signal of negative polarity associated with the first color image data; a third data signal of positive polarity associated with a second color image data; a fourth data signal of negative polarity associated with the second color image data; a fifth data signal of positive polarity associated with a third color image data; and a sixth data signal of negative polarity associated with the third color image data. The data line driver circuit supplies each of the six kinds of data signals for the same number of times during a predetermined period with respect to each data line.

### INCORPORATION BY REFERENCE

This application is based upon and claims the benefit of priority from Japanese patent application No. 2008-274481, filed on Oct. 24, 2008, the disclosure of which is incorporated herein in its entirety by reference.

### BACKGROUND OF THE INVENTION

1. Field of the Invention

The present invention relates to an active matrix liquid crystal display device. In particular, the present invention relates to an active matrix liquid crystal display device that uses a thin film transistor (TFT) as an active element.

2. Description of Related Art

A matrix-type liquid crystal display device in which liquid crystal cells are arranged in a matrix form is one of most typical display devices. The liquid crystal display device is provided with scanning lines and data lines. A scanning signal for selecting a row of the liquid crystal cells is supplied to the scanning line. A data signal is supplied to the data line. The liquid crystal cells are arranged at respective intersections of the scanning lines and the data lines. The liquid crystal cell has a TFT and a pixel electrode. Liquid crystal is provided between the pixel electrode and a common electrode.

The liquid crystal display device has a gate driver IC, a data driver IC, a signal control unit (T/C), a color filter, a backlight, a power source and the like. The gate driver IC supplies the scanning signal to the scanning line. The data driver IC supplies the data signal to the data line.

In the liquid crystal display device, voltage polarity of the data signal supplied to the pixel electrode is inverted every predetermined period, in order to suppress deterioration of the liquid crystal material. The inversion driving method includes frame inversion driving, column inversion driving, line inversion driving, dot inversion driving and the like. The dot inversion driving, in which adjacent liquid crystal cells are driven such that the respective voltage polarities are opposite to each other, is known to achieve high image quality.

Features of the dot inversion driving in the liquid crystal panel of a normal arrangement are as follows.

1. A voltage of the common electrode is fixed.

2. The scanning lines are driven by progressive scanning (noninterlace).

3. The voltage polarity of the data signal is different between two adjacent data lines.

4. The voltage polarity of the data signal supplied to each data line is inverted every horizontal period.

Japanese Laid-Open Patent Application JP-H10-073843 (hereinafter referred to as Patent Document 1) discloses the dot inversion driving. According to the Patent Document 1, even if the voltage polarity is the same between two adjacent data lines and not all the above-mentioned four features is satisfied, the dot inversion driving can be achieved by a connection relationship between the TFT and the scanning line and the data line. For this reason, a pattern in which the voltage polarity of a liquid crystal cell is apparently different from those of right, left, upper and lower adjacent liquid crystal cells is hereinafter referred to as a dot inversion pattern.

By the way, the Patent Document 1 and Japanese Laid-Open Patent Application JP-2006-178461 (hereinafter referred to as Patent Document 2) describe a “double scanning line method”. The double scanning line method is a technique for reducing costs of the data driver IC, in which the number of data driver ICs is reduced by halving the number of data lines. The number of scanning lines is doubled, while one data line is shared by two adjacent liquid crystal cells. Although the number of scanning lines is doubled, the cost is not increased when a scanning line driver circuit is formed on a substrate on which the liquid crystal cells are formed.

According to the double scanning line method described in the Patent Document 1, the voltage polarity of the data signal is inverted every one scanning period and thereby the dot inversion pattern is achieved. According to the double scanning line method described in the Patent Document 2, the voltage polarity of the data signal supplied to the data line is inverted every one frame and the column inversion driving is performed. In the case of the column inversion driving, flicker is caused by a vertical stripe pattern. Therefore, the data line is formed to snake, such that an apparent inversion driving becomes combination of the column inversion driving and the dot inversion driving to improve the image quality.

According to the technique described in the Patent Documents 1 and 2, two adjacent liquid crystal cells arranged between two adjacent data lines are concurrently driven. This can suppress a phenomenon that a liquid crystal cell connected to a data line and first driven is affected by the data signal supplied to a liquid crystal cell connected to the same data line and driven later and thus the voltage of the pixel electrode is varied.

Moreover, Japanese Laid-Open Patent Application JP-H07-295515 (hereinafter referred to as Patent Document 3) describes a “triple scanning line method”. According to the triple scanning line method, the color filters are arranged to be RGB horizontal stripe, the number of scanning lines is tripled, the number of data lines is reduced to one-third, and the number of data driver ICs is reduced.

However, in the case of the triple scanning line method, writing to the pixel electrode becomes insufficient when the number of scanning lines is increased, which deteriorates the image quality. There are two causes of the deterioration of the image quality. The first one is that one scanning period is decreased to one-third. The second one is that the triple TFT elements are connected to one data line and hence parasitic capacitance of the data line is increased. In this manner, not only one scanning period is shortened but also the parasitic capacitance is increased, which causes waveform rounding of the data signal, the insufficient writing to the pixel electrode and the deterioration in the image quality.

In the case of the triple scanning line method, the effect of reducing the number of data driver ICs is greater as compared with the double scanning line method. However, not only the above-mentioned insufficient writing is caused, but also a higher drive frequency causes increase in heat generation and EMI of the data driver IC, which are side effects. Therefore, there is a limit to high-definition representation.

Japanese Laid-Open Patent Application JP-2008-116964 (hereinafter referred to as Patent Document 4) discloses a technique in which the number of scanning lines is 3/2 times larger, the number of data lines is reduced to two-thirds, and the number of data driver ICs is reduced.

In the case of the double scanning line method, the problem of the insufficient writing to the pixel electrode is suppressed as compared with the triple scanning line method. Therefore, the double scanning line method is more likely to achieve high-definition as compared with the triple scanning line method.

The inventor of the present application has recognized the following points.

In the case of the double scanning line method described in the Patent Document 1, vertical unevenness is caused by halftone raster pattern such as cyan, magenta and yellow. The main reason is that the voltage of the pixel electrode is varied due to off-leakage current of the TFT generated when the scanning line is not selected. In a case where a color filter arrangement is a vertical stripe arrangement of three colors (RGB), three patterns are possible for a combination of two liquid crystal cells sharing one data line: a liquid crystal cell R (Red) and a liquid crystal cell G (Green); a liquid crystal cell G and a liquid crystal cell B (Blue); and a liquid crystal cell B and a liquid crystal cell R. Here, let us focus on the liquid crystal cell G, as an example. There are both a column where the liquid crystal cell G shares the one data line with the liquid crystal cell R and a column where the liquid crystal cell G shares the one data line with the liquid crystal cell B. Therefore, when the data signal for the liquid crystal cell R is different from the data signal for the liquid crystal cell B as in the case of the halftone raster pattern such as cyan and yellow, the vertical unevenness is caused. The same applies to the cases of the liquid crystal cell R and the liquid crystal cell B. As described above, according to the double scanning line method described in the Patent Document 1, crosstalk is caused by difference in color of the sharing liquid crystal cell, which is a problem.

In the case of the column inversion driving according to the Patent Document 2, brightness shading is generated in a vertical direction of a display panel, and vertical crosstalk of a window pattern is caused. As to liquid crystal cells in the first-driven row, the data signal having the same voltage polarity as the voltage of the pixel electrode is supplied over almost all periods. As to liquid crystal cells in the lastly-driven row, the data signal having the opposite voltage polarity to the voltage of the pixel electrode is supplied over almost all periods. Thus, the off-leakage current of the TFT greatly differs depending on position, and the brightness shading and the crosstalk are not improved. Even though the flicker due to the vertical stripe pattern may be suppressed, the brightness shading and the crosstalk cannot be suppressed by merely making the data line snake, which is a problem.

According to the Patent Document 4, pixels in two rows are selected during one scanning period. An R (Red) row and a G (Green) row, a G row and a B (Blue) row, and a B row and an R row are concurrently selected from a pixel matrix. In a case of the vertical stripe pattern where one color among the three colors (R, G, B) is at a non-display level and the other two colors are at an immediate gray-scale level, variation in the common voltage is different. This causes the flicker and crosstalk, which is a problem.

### SUMMARY

In an aspect of the present invention, a liquid crystal display device is provided. The liquid crystal display device has a liquid crystal panel and a data line driver circuit. The liquid crystal panel has liquid crystal cells that are arranged in a matrix form at respective intersections of a plurality of data lines and a plurality of scanning lines. The data line driver circuit is configured to supply data signals to the plurality of data lines. The data signals include six kinds of data signals: a first data signal of positive polarity associated with a first color image data; a second data signal of negative polarity associated with the first color image data; a third data signal of positive polarity associated with a second color image data; a fourth data signal of negative polarity associated with the second color image data; a fifth data signal of positive polarity associated with a third color image data; and a sixth data signal of negative polarity associated with the third color image data. The data line driver circuit switches the six kinds of data signals and supplies each of the six kinds of data signals for the same number of times during a predetermined period with respect to each of the plurality of data lines.

In another aspect of the present invention, a method of driving a liquid crystal display device is provided. The method includes: supplying each of six kinds of data signals for the same number of times during a first predetermined period, with respect to one data line. The six kinds of data signals include: a first data signal of positive polarity associated with a first color image data; a second data signal of negative polarity associated with the first color image data; a third data signal of positive polarity associated with a second color image data; a fourth data signal of negative polarity associated with the second color image data; a fifth data signal of positive polarity associated with a third color image data; and a sixth data signal of negative polarity associated with the third color image data. The method further includes: supplying each of the six kinds of data signals for the same number of times during a second predetermined period whose length is equal to that of the first predetermined period, with respect to the one data line.

According to the present invention, the brightness shading and the crosstalk are substantially prevented and excellent image quality can be achieved, particularly in a liquid crystal display device based on the double scanning line method.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing a configuration of a liquid crystal display device according to an embodiment of the present invention;

FIG. 2 illustrates an arrangement configuration in the 1st arrangement example;

FIG. 3 is a circuit diagram showing a configuration of a data line driver circuit;

FIG. 4 is a timing chart for explaining an operation of the data line driver circuit;

FIG. 5 illustrates an arrangement configuration in the 2nd arrangement example;

FIG. 6 illustrates an arrangement configuration in the 3rd arrangement example;

FIG. 7 illustrates an arrangement configuration in the 4th arrangement example;

FIG. 8 illustrates an arrangement configuration in the 5th arrangement example;

FIG. 9 illustrates an arrangement configuration in the 6th arrangement example;

FIG. 10 illustrates an arrangement configuration in the 7th arrangement example;

FIG. 11 illustrates an arrangement configuration in the 9th arrangement example;

FIG. 12 illustrates an arrangement configuration in the 10th arrangement example;

FIG. 13 illustrates an arrangement configuration in the 11th arrangement example;

FIG. 14 is an explanatory diagram about polarity of data signal;

FIG. 15A is a circuit diagram showing a polarity switch unit in the data line driver circuit;

FIG. 15B is a circuit diagram showing a polarity switch unit in the data line driver circuit;

FIG. 15C is a circuit diagram showing a polarity switch unit in the data line driver circuit;

FIG. 15D is a circuit diagram showing a polarity switch unit in the data line driver circuit;

FIG. 16 illustrates an arrangement configuration in the 12th arrangement example;

FIG. 17A is a circuit diagram showing a polarity switch unit in the data line driver circuit;

FIG. 17B is a circuit diagram showing a polarity switch unit in the data line driver circuit;

FIG. 18 illustrates an arrangement configuration in the 13th arrangement example;

FIG. 19 illustrates an arrangement configuration in the 14th arrangement example;

FIG. 20 illustrates an arrangement configuration in the 15th arrangement example;

FIG. 21 is a timing chart showing an operation in the 15th arrangement example;

FIG. 22 illustrates an arrangement configuration in the 16th arrangement example;

FIG. 23 illustrates an arrangement configuration in the 17th arrangement example; and

FIG. 24 illustrates an arrangement configuration in the 18th arrangement example.

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

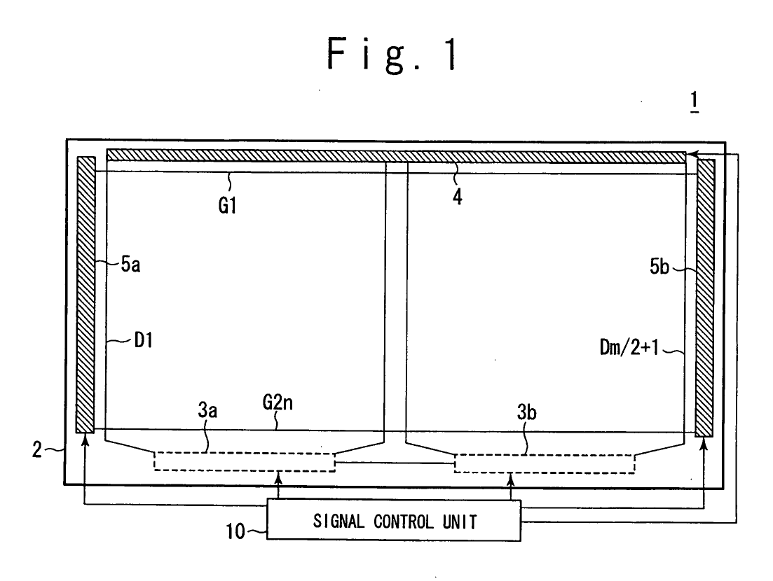

FIG. 1 shows a configuration of a liquid crystal display device 1 according to the present embodiment. In FIG. 1, the liquid crystal display device 1 has a liquid crystal panel 2 in which liquid crystal cells each including a TFT element are arranged in a matrix form. The liquid crystal panel 2 is further provided with a plurality of scanning lines (G1, G2, . . . , G2n−1, G2n) for selecting a row of the liquid crystal cells and a plurality of data lines (D1, D2, . . . , Dm/2, Dm/2+1) to which data signals are supplied. The liquid crystal cells are arranged at respective intersections of the scanning lines and the data lines. Each liquid crystal cell has a pixel electrode, and liquid crystal is provided between the pixel electrode and a common electrode. A gate electrode of the TFT is connected to one of the scanning lines. A source electrode of the TFT is connected to one of the data lines. A drain electrode of the TFT is connected to the pixel electrode. Sometimes, the scanning line is called a gate line and the data line is called a source line.

The scanning line is connected to scanning line driver circuits 5a and 5b that supply a scanning signal. The scanning line driver circuit 5a and 5b can be formed on the liquid crystal panel 2, because it requires neither voltage precision nor high-speed operation. It is preferable that the scanning line driver circuits 5a and 5b respectively formed on both left and right sides concurrently drive one scanning line, in order to prevent brightness shading in the horizontal direction due to waveform rounding of the scanning signal from occurring.

The data line is connected to data line driver circuit 3a or 3b that supplies the data signal. Shown in FIG. 1 is an example where two data line driver circuits 3a and 3b are used. Note that components such as a power source and a backlight are not shown.

The data line driver circuits 3a, 3b, the scanning line driver circuits 5a and 5b are controlled by control signals generated by a signal control unit 10. A horizontal synchronizing signal Hsync, a vertical synchronizing signal Vsync, an image data DAT, a clock signal CLK and the like (not shown) are supplied to the signal control unit 10. The signal control unit 10 performs reordering of the image data in accordance with color and polarity of each liquid crystal cell and then supplies the image data to the data line driver circuits 3a and 3b. Also, the signal control unit 10 generates control signals such as a RES signal and a POL signal and supplies them to the data line driver circuits 3a and 3b.

The liquid crystal display device 1 shown in FIG. 1 is WXGA (Wide eXtended Graphics Array: 1280×768 pixels) of RGB vertical stripe arrangement.

A first direction is the vertical direction, and a second direction is the horizontal direction. A vertical number of effective liquid crystal cells in the first direction is 768. A horizontal number of effective liquid crystal cells in the second direction is 3840 (=1280×3). Moreover, the liquid crystal display device 1 is based on the double scanning line method (RGB vertical stripe arrangement). Two scanning lines are provided for each row. A total number of scanning lines is 1536 which is twice the vertical number of effective liquid crystal cells other than dummy liquid crystal cells. In one row, one data line is shared by two adjacent liquid crystal cells. A total number of data lines is 1920 which is half the horizontal number of effective liquid crystal cells other than dummy liquid crystal cells.

In the present embodiment, a number of columns is 1920+α (α: natural number) because of a liquid crystal cell arrangement including dummy columns. In each data line driver circuit 3a, 3b supporting the dot inversion driving, a positive polarity D/A conversion unit and a negative polarity D/A conversion unit are the same in number, and thus the number of outputs of the each data line driver circuit 3a, 3b is preferably an even number. For example, two data line driver circuits 3a and 3b each having 962 outputs may be used in one liquid crystal panel.

There are six kinds of data signals as a result of combination of three colors (R, G, B) and two voltage polarities (positive polarity, negative polarity). In order to distinguish the six kinds of data signals, each data signal is referred to as follows. When a positive polarity data signal associated with the image data of R (red color, red) is supplied to a liquid crystal cell, the data signal is referred to as a [R, positive]-signal (or a first data signal). When a negative polarity data signal associated with the image data of R (red color, red) is supplied to a liquid crystal cell, the data signal is referred to as a [R, negative]-signal (or a second data signal). When a positive polarity data signal associated with the image data of G (green color, green) is supplied to a liquid crystal cell, the data signal is referred to as a [G, positive]-signal (or a third data signal). When a negative polarity data signal associated with the image data of G (green color, green) is supplied to a liquid crystal cell, the data signal is referred to as a [G, negative]-signal (or a fourth data signal). When a positive polarity data signal associated with the image data of B (blue color, blue) is supplied to a liquid crystal cell, the data signal is referred to as a [B, positive]-signal (or a fifth data signal). When a negative polarity data signal associated with the image data of B (blue color, blue) is supplied to a liquid crystal cell, the data signal is referred to as a [B, negative]-signal (or a sixth data signal).

In the liquid crystal panel 2 of the present embodiment, the cell arrangement is the RGB vertical stripe arrangement, the first direction is the vertical direction, two scanning lines are provided for each row, and one data line is shared by two adjacent liquid crystal cells. With respect to each data line, each of the six kinds of data signals is supplied for the same number of times during a predetermined period when one block is scanned. Consequently, the display unevenness can be suppressed. A concrete arrangement example of the liquid crystal cells, the data lines and the scanning lines will be described below.

### 1st Arrangement Example

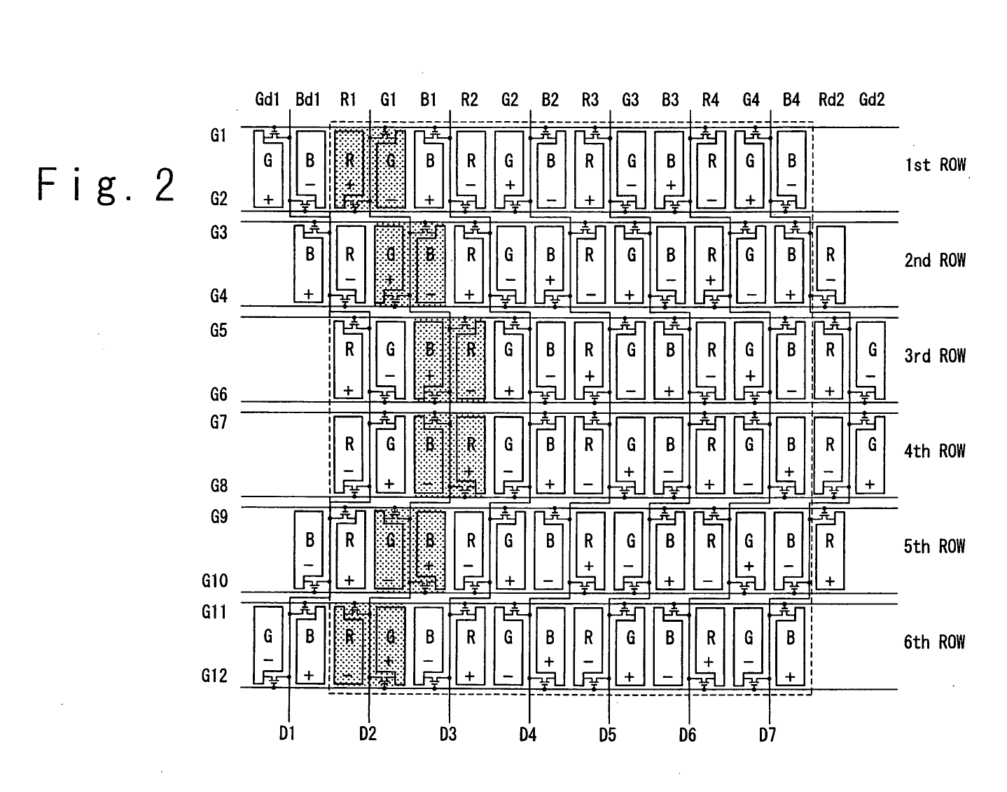

An arrangement of the scanning lines, the data lines and the liquid crystal cells according to the 1st arrangement example will be described below with reference to FIG. 2. The color filter arrangement is the vertical stripe arrangement of three colors (R, G, B). For convenience, a reference numeral is given to each column of the liquid crystal cells in order from the left side. The 1st column is column Gd1, the 2nd column is column Bd1, the 3rd column is column R1, the 4th column is column G1, the 5th column is column B1, . . . , the 12th column is column R4, the 13th column is column G4, the 14th column is column B4, the 15th column is column Rd2 and the 16th column is column Gd2. The effective horizontal liquid crystal cells include twelve columns from the column R1 to the column B4.

Each liquid crystal cell in the column R1, column R2, column R3 and column R4 is covered by a color filter of red. Each liquid crystal cell in the column G1, column G2, column G3 and column G4 is covered by a color filter of green. Each liquid crystal cell in the column B1, column B2, column B3 and column B4 is covered by a color filter of blue. Respective two columns on the left and right sides (Gd1, Bd1, Rd2 and Gd2) are dummy columns that are shaded. A liquid crystal cell covered by the color filter of red is hereinafter referred to as a liquid crystal cell R. A liquid crystal cell covered by the color filter of green is hereinafter referred to as a liquid crystal cell G. A liquid crystal cell covered by the color filter of blue is hereinafter referred to as a liquid crystal cell B.

One pixel includes three liquid crystal cells of 3 columns (RGB)×1 row. According to the liquid crystal display device 1 in the 1st arrangement example, as shown, one block includes a group of liquid crystal cells of twelve columns (from the column R1 to the column B4) and six rows (from the 1st row to the 6th row), namely 4×6 pixels that are arranged in a matrix form. There are 320×128 blocks as a whole in the case of WXGA.

As shown in FIG. 2, the dummy columns Gd1, Bd1, Rd2 and Gd2 are provided on both left and right sides of the effective display region of the liquid crystal panel 2. For the purpose of distinguishing blocks, the block including the columns R1 to B4 and the 1st to 6th rows surrounded by a dashed line in FIG. 2 is hereinafter referred to as a first block. A block located below the first block and including the 7th to 12th rows (not shown) is hereinafter referred to as a second block. For illustrative purpose, FIG. 2 shows only the first block as the effective display region on both sides of which the dummy column liquid crystal cells are placed. In reality, however, the effective display region consists of a plurality of blocks and no dummy column exists between adjacent blocks.

One block includes many liquid crystal cells. For the purpose of distinguishing the liquid crystal cells, a liquid crystal cell in the column R1 and 1st row is referred to as liquid crystal cell (R1, 1), a liquid crystal cell in the column G1 and 1st row is referred to as liquid crystal cell (G1, 1), and a liquid crystal cell in the column B1 and 1st row is referred to as liquid crystal cell (B1, 1). The same applies to the other liquid crystal cells. For example, a liquid crystal cell in the column R3 and 2nd row is referred to as liquid crystal cell (R3, 2).

The liquid crystal cells in one row is connected a pair of scanning lines. For the purpose of distinguishing the scanning lines, the scanning lines connected to the liquid crystal cells in the 1st row are referred to as scanning lines G1 and G2. The same applies to the other rows. Respective pairs of scanning lines connected to the liquid crystal cells in the 1st to n-th rows are the scanning lines G1, G2, scanning lines G3, G4, . . . , scanning lines G2n−1, G2n (n: natural number).

A connection relationship between the scanning lines G1, G2 and the liquid crystal cells in the 1st row is as follows. The liquid crystal cell (Gd1, 1), the liquid crystal cell (G1, 1), the liquid crystal cell (B1, 1), the liquid crystal cell (B2, 1), the liquid crystal cell (R3, 1), the liquid crystal cell (R4, 1) and the liquid crystal cell (G4, 1) are connected to the scanning line G1. The liquid crystal cell (Bd1, 1), the liquid crystal cell (R1, 1), the liquid crystal cell (R2, 1), the liquid crystal cell (G2, 1), the liquid crystal cell (G3, 1), the liquid crystal cell (B3, 1) and the liquid crystal cell (B4, 1) are connected to the scanning line G2.

A connection relationship between the data lines D2, D3 and the liquid crystal cells in the 1st row is as follows. The liquid crystal cell (R1, 1) and the liquid crystal cell (G1, 1) are connected to the data line D2. The liquid crystal cell (B1, 1) and the liquid crystal cell (R2, 1) are connected to the data line D3. In one row, RGB liquid crystal cells are arranged repeatedly every three columns. Here, the connection relationship between the two data lines D2, D3 and the liquid crystal cells is explained, and an explanation of a connection relationship between the other data lines and the liquid crystal cells is omitted.

In the present embodiment, two adjacent liquid crystal cells arranged between two adjacent data lines, such as the liquid crystal cell (G1, 1) and the liquid crystal cell (B1, 1), are connected to the same scanning line. This can suppress a phenomenon that a voltage of a liquid crystal cell first driven is affected by a liquid crystal cell driven later and thus the voltage of the pixel electrode is varied. In other words, the crosstalk due to coupling capacitance between the pixel electrodes is suppressed by concurrently driving two adjacent liquid crystal cells respectively connected to different data lines. This technique is described also in the Patent Document 1 and the Patent Document 2. However, there are also other causes of the crosstalk and thus the image quality is not so good.

According to the present embodiment, the following technique is further employed in order to reduce the vertical unevenness caused by crosstalk due to a leakage current at the time when the TFT is turned off and crosstalk due to coupling capacitance between the pixel electrode and the data line. First, each data line is so formed as to meander (snake). The meandering of each data line is as follows. As shown in FIG. 2, each data line shifts to the right by one liquid crystal cell between the 1st row and the 2nd row, and further shifts to the right by one liquid crystal cell between the 2nd row and the 3rd row. Each data line does not shift between the 3rd row and the 4th row. Each data line shifts to the left by one liquid crystal cell between the 4th row and the 5th row, and further shifts to the left by one liquid crystal cell between the 5th row and the 6th row. Each data line does not shift between the 6th row and the 7th row (the 1st row in the second block). Each data line thus configured is connected to liquid crystal cells of the same color in different columns.

A connection relationship between the scanning lines and the liquid crystal cells in and below the 2nd row is as follows. Here, the four columns R1, G1, B1 and R2 will be explained, and explanation of the other columns will be omitted because the same pattern appears every three columns. An arrangement of the liquid crystal cells in the 2nd row is obtained by shifting the arrangement in the 1st row to the right by one liquid crystal cell. The liquid crystal cell (B1, 2) and the liquid crystal cell (R2, 2) are connected to the scanning line G3, and the liquid crystal cell (R1, 2) and the liquid crystal cell (G1, 2) are connected to the scanning line G4. An arrangement of the liquid crystal cells in the 3rd row is obtained by shifting the arrangement in the 2nd row to the right by one liquid crystal cell. The liquid crystal cell (R1, 3) and the liquid crystal cell (R2, 3) are connected to the scanning line G5, and the liquid crystal cell (G1, 3) and the liquid crystal cell (B1, 3) are connected to the scanning line G6.

An arrangement of the liquid crystal cells in the 4th to 6th rows is obtained by mirror-inverting the arrangement in the 1st to 3rd rows with respect to a center line between the 3rd row and the 4th row as the inversion axis. The liquid crystal cell (G1, 4) and the liquid crystal cell (B1, 4) are connected to the scanning line G7, and the liquid crystal cell (R1, 4) and the liquid crystal cell (R2, 4) are connected to the scanning line G8. An arrangement of the liquid crystal cells in the 5th row is obtained by shifting the arrangement in the 4th row to the left by one liquid crystal cell. The liquid crystal cell (R1, 5) and the liquid crystal cell (G1, 5) are connected to the scanning line G9, and the liquid crystal cell (B1, 5) and the liquid crystal cell (R2, 5) are connected to the scanning line G10. An arrangement of the liquid crystal cells in the 6th row is obtained by shifting the arrangement in the 5th row to the left by one liquid crystal cell. The liquid crystal cell (R1, 6) and the liquid crystal cell (R2, 6) are connected to the scanning line G11, and the liquid crystal cell (G1, 6) and the liquid crystal cell (B1, 6) are connected to the scanning line G12. It should be noted that the color filter arrangement still remains the RGB vertical stripe.

A connection relationship between the data lines D2, D3 and the liquid crystal cells is as follows. The liquid crystal cells (G1, 1), (R1, 1), (B1, 2), (G1, 2), (R2, 3), (B1, 3), (B1, 4), (R2, 4), (G1, 5), (B1, 5), (R1, 6) and (G1, 6) are connected to the data line D2. A hatching section in FIG. 2 indicates the liquid crystal cells connected to the data line D2. The liquid crystal cells (B1, 1), (R2, 1), (R2, 2), (G2, 2), (G2, 3), (B2, 3), (B2, 4), (G2, 4), (G2, 5), (R2, 5), (R2, 6) and (B1, 6) are connected to the data line D3. A connection relationship between the liquid crystal cells and each of the data lines D4 and D6 is similar to the above-mentioned connection relationship between the liquid crystal cells and the data line D2, although there are differences in the color and the voltage polarity of the data signal supplied to the pixel electrode. A connection relationship between the liquid crystal cells and each of the data lines D1, D5 and D7 is similar to the above-mentioned connection relationship between the liquid crystal cells and the data line D3, although there are differences in the color and the voltage polarity of the data signal supplied to the pixel electrode.

The liquid crystal cells in the dummy column will be explained below. In the first block, if the data line D1, D7 is not connected to the liquid crystal cell in the dummy column, its parasitic capacitance becomes different from that of each of the data lines D2 to D6. Difference in impedance of the data line leads to difference in the waveform of the data signal, which causes the display unevenness. In order to suppress the display unevenness, each data line needs to have the same impedance. For this reason, the liquid crystal cells (Gd1, 1), (Bd1, 1), (Bd1, 2), (R1, 2), (R1, 3), (G1, 3), (R1, 4), (G1, 4), (Bd1, 5), (R1, 5), (Gd1, 6) and (Bd1, 6) are connected to the data line D1. Also, the liquid crystal cells in the dummy columns are connected to the data line D7, as in the case of the data line D1. In reality, the liquid crystal panel 2 consists of a plurality of blocks. Therefore, if the first block is the leftmost block in the liquid crystal panel 2, the data line D7 is actually connected to the liquid crystal cells in the effective display region of the adjacent block (not shown).

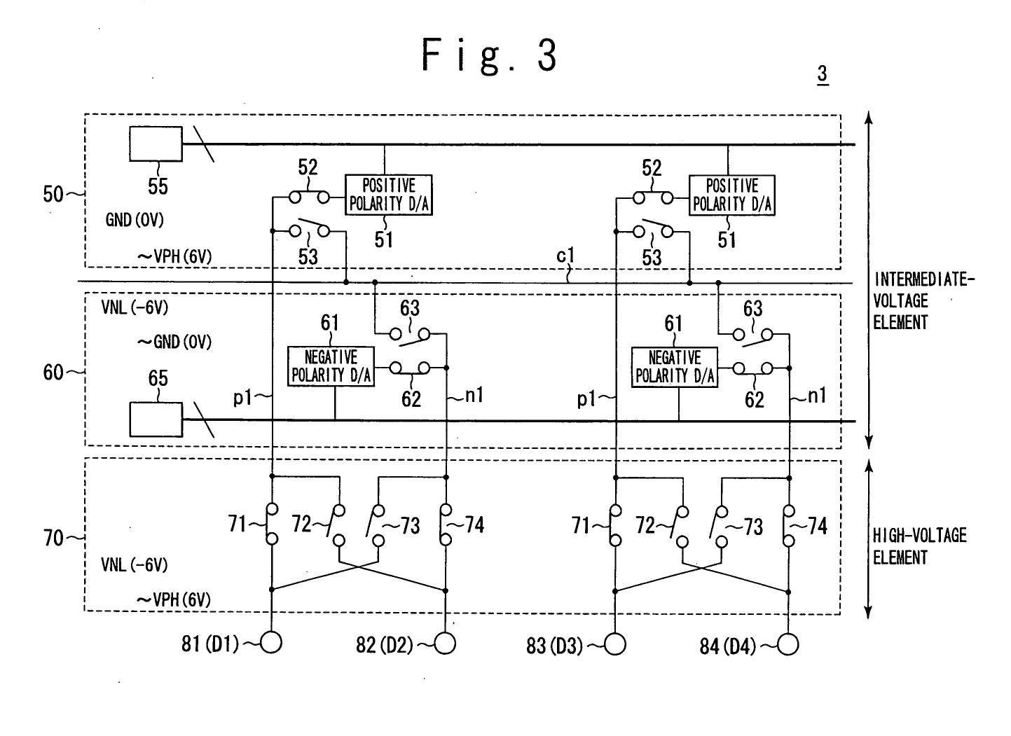

The data line driver circuit 3a, 3b in the liquid crystal display device 1 shown in FIG. 1 supports the dot inversion driving. A configuration of the data line driver circuit 3a, 3b will be explained below with reference to FIG. 3. Shown in FIG. 3 is a partial circuit configuration related to four data lines D1 to D4. In the present embodiment, the data line driver circuit 3a, 3b has a positive polarity driver unit 50 outputting a positive polarity data signal, a negative polarity driver unit 60 outputting a negative polarity data signal, a polarity switch unit 70 and output terminals 81 to 84. The data line driver circuit 3a, 3b further has input terminals for the image data, the clock signal, the power source and the like, a timing controller, shift registers, data buffers, data latches, level shifters, protectors and the like (not shown).

In a case of an amplitude-modulation liquid crystal driving, high precision is required for the driver units 50 and 60 of the data line driver circuit 3a, 3b, and thus the driver units 50 and 60 are integrated on a semiconductor substrate such as a silicon substrate. Packaging of the data line driver circuit 3a, 3b can be COG (Chip on Glass), COF (Chip on Film), TCP (Tape Carrier Package) and the like. The output terminals 81 to 84 of the data line driver circuit 3a, 3b are respectively connected to the data lines D1 to D4 through anisotropic conductive films.

The positive polarity driver unit 50 outputs a positive polarity data signal depending on the image data. The positive polarity driver unit 50 has a positive polarity D/A converter 51, switches 52, 53 and a positive polarity gray-scale voltage generation unit 55. The switch 52 is provided between the positive polarity D/A converter 51 and a node p1, and the switch 53 is provided between the node p1 and a common line c1.

The negative polarity driver unit 60 outputs a negative polarity data signal depending on the image data. The negative polarity driver unit 60 has a negative polarity D/A converter 61, switches 62, 63 and a negative polarity gray-scale voltage generation unit 65. The switch 62 is provided between the negative polarity D/A converter 61 and a node n1, and the switch 63 is provided between the node n1 and the common line c1.

For the purpose of reducing heat-production in the data line driver circuit 3a, 3b, the positive polarity driver unit 50 and the negative polarity driver unit 60 are operated with half the LCD drive voltage. The positive polarity driver unit 50 operates with voltages of GND (0 V) and VPH (6 V). The negative polarity driver unit 60 operates with voltages of VNL (−6 V) and GND (0 V). The positive polarity driver unit 50 and the negative polarity driver unit 60 are formed of intermediate-voltage elements. A breakdown voltage of the intermediate-voltage element is 7 V, for example. The reference voltage is not limited to the GND (0 V). For example, the reference voltage may be 8 V. In this case, the positive polarity driver unit 50 may operate with 8 V and 16 V, and the negative polarity driver unit 60 may operate with 0 V and 8 V. The breakdown voltage of the intermediate-voltage element is 9 V, for example.

The positive polarity D/A converter 51 and the negative polarity D/A converter 61 each has a decoder, a gray-scale voltage selector and a buffer amplifier. The gray-scale voltage selector selects a gray-scale voltage signal corresponding to the image data. The buffer amplifier outputs an impedance-converted data signal. The number of the positive polarity D/A converters 51 and the number of the negative polarity D/A converters 61 are “the number of data lines/2”, respectively. Note that each of the data line driver circuits 3a and 3b just needs to have one positive polarity gray-scale voltage generation unit 55 and one negative polarity gray-scale voltage generation unit 65. The positive polarity driver unit 50 and the negative polarity driver unit 60 are electrically isolated from each other by using deep well or SOI (Silicon on Insulator).

The positive polarity gray-scale voltage generation unit 55 generates positive polarity gray-scale voltages by voltage-dividing a reference voltage by using a resistor string. Similarly, the negative polarity gray-scale voltage generation unit 65 generates negative polarity gray-scale voltages by voltage-dividing a reference voltage by using a resistor string.

The polarity switch unit 70 includes a plurality of switches 71 to 74. The switch 71 is provided between the node p1 and the output terminal 81. The switch 72 is provided between the node p1 and the output terminal 82. The switch 73 is provided between the node n1 and the output terminal 81. The switch 74 is provided between the node n1 and the output terminal 82. The polarity switch unit 70 can operate with voltages not more than VNL (−6 V) and not less than VPH (6 V). For example, the polarity switch unit 70 may be operated with a scanning-off voltage Vgoff (−15 V) and a scanning-on voltage Vgon (20 V). The voltage value in parenthesis is just an example. The polarity switch unit 70 is formed of high-voltage elements. A breakdown voltage of the high-voltage element is 13 V or 38 V, for example.

The polarity switch unit 70 may be formed on the liquid crystal panel 2, as in the case of the scanning line driver circuits 5a and 5b. When the ON resistance of each of the switches 71 to 74 is Ron, heat proportional to Ron is generated. By forming the polarity switch unit 70 on the liquid crystal panel 2, the generated heat can be dispersed on the liquid crystal panel 2 and hence rise in temperature of the data line driver circuit 3a, 3b can be reduced.

Furthermore, a neutralization switch 4 may be provided on the liquid crystal panel 2 on the opposite side of the data line driver circuit 3a, 3b. The neutralization switch 4 short-circuits the data lines with each other. Consequently, a precharge time for each scanning period (1 G period) can be reduced. Moreover, heat at the time of precharging is dispersed on the liquid crystal panel 2 and hence rise in temperature of the data line driver circuit 3a, 3b can be reduced. Furthermore, current concentration on a power-supply line of the data line driver circuit 3a, 3b can be lessened and thus EMI can be reduced.

Next, a method of driving the scanning lines, the data lines and the common electrode will be described below. In the present embodiment, the dot inversion driving is employed. That is, the scanning lines are driven sequentially (G1→G2→G3→G4 . . . G2n−1→G2n), and the voltage (common voltage) of the common electrode is fixed. Adjacent data lines are different in the voltage polarity. The voltage polarity of the data signal supplied to the data line is inverted every one scanning period. The voltage polarity of each liquid crystal cell is inverted every one frame. When two successive scanning lines (G2i−1, G2i) constitute one scanning group, scanning order in each scanning group may be reversed every one or two frame periods. For example, the scanning order during the first and second frame periods is G1→G2→G3→G4→ . . . →G2i−1→G2i→ . . . →G2n−1→G2n, and the scanning order during the third and fourth frame periods is G2→G1→G4 G3→G2i→G2i−1→ . . . →G2n→G2n−1. When an interval of the horizontal synchronizing signal Hsync is one horizontal period (hereinafter referred to as 1 H period), the 1 G period is equal to half the horizontal period (½ H period). According to the arrangement of the liquid crystal cells in the present embodiment, the apparent inversion pattern is the dot inversion pattern.

If the 1 G period is shortened and a writing time for the pixel electrode is shortened, the crosstalk is more likely to occur due to influence by the former data signal. In order to reduce the influence by the former data signal, the voltage of each data line just needs to be set to the same voltage before the scanning line is selected. For that purpose, each data line is precharged to an intermediate voltage every 1 G period. Alternatively, each data line may be set to near the intermediate voltage every 1 G period by short-circuiting all the data lines with each other. In the case where each data line is precharged every 1 G period, the gray-scale voltage can be easily corrected depending on a distance from the data line driver circuit 3a, 3b. For example, the gray-scale voltage generated by the gray-scale voltage generation unit 55, 65 is corrected depending on the distance from the data line driver circuit 3a, 3b.

When the data signal is inverted every 1 G period, power consumption at the data line is increased as compared with the case of the column inversion driving. However, when the data line driver circuit 3a, 3b is designed to be dedicated to 1 G inversion driving, the positive polarity buffer amplifier is a voltage rising amplifier and the negative polarity buffer amplifier is a voltage falling amplifier, which can simplify the circuit configuration. Moreover, if a driving method other than the 1 G inversion driving method is required, each switch in the polarity switch unit 70 needs to be a transfer switch and the ON resistance needs to be independent of the gray-scale voltage. However, in the case of 1 G inversion dedicated, the switch 71, 72 can be a Pch transistor and the switch 73, 74 can be an Nch transistor. In this manner, in the case of 1 G inversion dedicated, consumption current of the amplifier can be reduced and a chip size of the data line driver circuit 3a, 3b can be reduced.

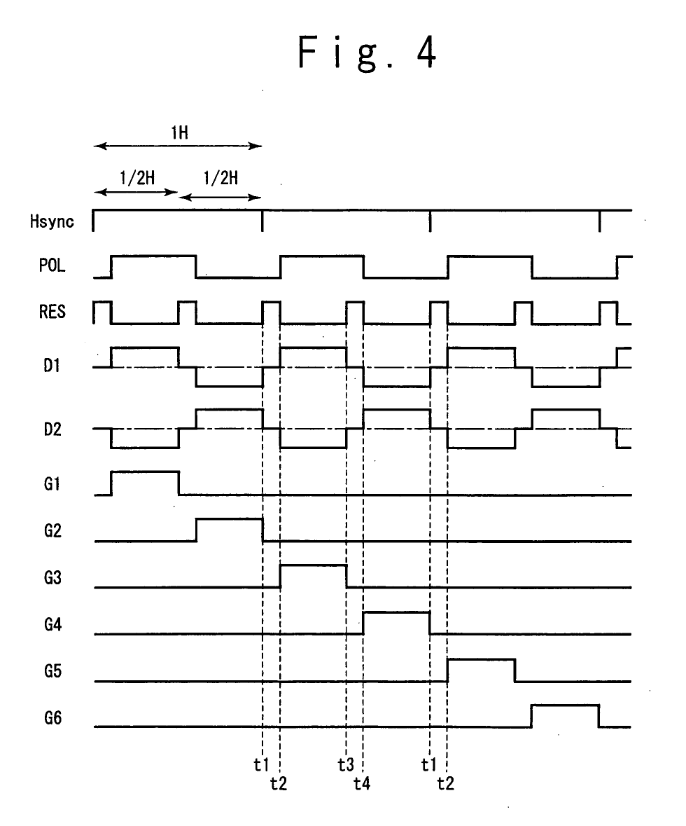

An operation of the data line driver circuit 3a, 3b will be described below with reference to a timing chart shown in FIG. 4. In FIG. 4, a horizontal synchronizing signal Hsync is a control signal for synchronizing every one horizontal period, and a half time of one horizontal period is equal to one scanning period (1 G=½ H). A polarity control signal POL is a signal for controlling the voltage polarity of the data signal. A reset signal RES is a control signal for precharging the data line. The data signals D1 and D2 are analog signals output from the data line driver circuit 3a, 3b. The scanning signals G1 to G6 are digital signals output from the scanning line driver circuit 5a, 5b.

When the reset signal RES is “H”, the switches 52 and 62 are turned OFF and the switches 53 and 63 are turned ON. When the reset signal RES is “L”, the switches 52 and 62 are turned ON and the switches 53 and 63 are turned OFF. When the polarity control signal POL is “H”, the switches 71 and 74 are turned ON and the switches 72 and 73 are turned OFF. When the polarity control signal POL is “L”, the switches 71 and 74 are turned OFF and the switches 72 and 73 are turned ON.

As shown in FIG. 4, at a time t1, a selected scanning line turns to the OFF level (Vgoff). In a period until the next scanning line is selected, the reset signal RES is “H”. When the reset signal RES is “H”, the switches 52 and 62 are turned OFF and the switches 53 and 63 are turned ON, and thereby each data line is precharged to the reference voltage. At a time t2, the reset signal RES turns to “L” and the polarity control signal POL turns to “H”. As a result, the switches 52 and 62 are turned ON, the switches 53 and 63 are turned OFF, the switches 71 and 74 are turned ON, and the switches 72 and 73 are turned OFF. At this time, the positive polarity data signals are output from the output terminals 81 and 83, and the negative polarity data signals are output from the output terminals 82 and 84. At a time t3, each data line is precharged to the reference voltage, as in the case of the time t1. At a time t4, the reset signal RES turns to “L” and the polarity control signal POL turns to “L”. As a result, the switches 52 and 62 are turned ON, the switches 53 and 63 are turned OFF, the switches 71 and 74 are turned OFF, and the switches 72 and 73 are turned ON. At this time, the negative polarity data signals are output from the output terminals 81 and 83, and the positive polarity data signals are output from the output terminals 82 and 84.

The colors and the polarities of the data signals supplied to the liquid crystal cells (R1, 1), (G1, 1), (G1, 2), (B1, 2), . . . , (R1, 6) and (G1, 6) connected to the data line D2 are as follows. The data line driver circuit 3a, 3b supplies the [G, negative]-signal, the [R, positive]-signal, the [B, negative]-signal, the [G, positive]-signal, the [R, negative]-signal and the [B, positive]-signal in this order to the liquid crystal cells (G1, 1), (R1, 1), (B1, 2), (G1, 2), (R2, 3) and (B1, 3) connected to the scanning lines G1 to G6, respectively. Also, the data line driver circuit 3a, 3b supplies the [B, negative]-signal, the [R, positive]-signal, the [G, negative]-signal, the [B, positive]-signal, the [R, negative]-signal and the [G, positive]-signal in this order to the liquid crystal cells (B1, 4), (R2, 4), (G1, 5), (B1, 5), (R1, 6) and (G1, 6) connected to the scanning lines G7 to G12, respectively.

In this manner, the data line driver circuit 3a, 3b supplies each of the six kinds of data signals (the first to sixth data signals) for one time during the 3 H period when the scanning lines G1 to G6 are selected. Also, the data line driver circuit 3a, 3b supplies each of the six kinds of data signals for one time during the 3 H period when the scanning lines G7 to G12 are selected. That is to say, regarding one block, the data line driver circuit 3a, 3b supplies each of the six kinds of data signals (the first to sixth data signals) for the same number of times (twice) during the 6 H period. The same applies to other data lines D1, D3 to D7, although the sequence of the [color, polarity]-signals is different. That is to say, each of the six kinds of data signals is supplied for the same number of times (twice) to each data line during the 6 H period.

As described above, the data line driver circuit 3a, 3b in the present embodiment supplies each of the six kinds of data signals for the same number of times during a predetermined period when the one block is driven. As a result, a sum of the leakage current depending on the color and voltage polarity of each liquid crystal cell becomes uniform. Therefore, the display unevenness is suppressed. Moreover, since the voltage polarity of the data signal supplied to the data line is inverted every 1 G period, the brightness shading in the vertical direction and the vertical crosstalk of the window pattern can be suppressed.

In the liquid crystal display device, a major cause of horizontal crosstalk is fluctuation of the common voltage. In a case of the line inversion driving where the voltage polarity of the common voltage is inverted every one scanning period, the data signal having the same polarity is supplied from each data line during the same scanning period. Therefore, the common voltage becomes unstable and the horizontal crosstalk is likely to occur. In the case of the dot inversion driving, a sum of the voltage levels of the positive polarity data signals and a sum of the voltage levels of the negative polarity data signals are approximately the same during the same scanning period, and thus the common voltage is stabled. According to the present embodiment, the six kinds of data signals (the first to sixth data signals) are supplied to the six liquid crystal cells connected to one data line in one block. Consequently, the common voltage is stabled and the horizontal crosstalk can be suppressed.

In the liquid crystal panel based on the double scanning line method, the display unevenness is caused by the crosstalk due to the coupling capacitance between the pixel electrodes, the crosstalk due to the coupling capacitance between the pixel electrode and the data line, the crosstalk due to the off-leakage current of TFT, the crosstalk due to the fluctuation of the common voltage and so forth. According to the present embodiment, however, the causes of the crosstalks can be suppressed all together and thus excellent image quality can be achieved.

### 2nd Arrangement Example

Let us focus on the data line D2 in FIG. 2. As for the liquid crystal cell (G1, 1), the liquid crystal cell (G1, 2) and the liquid crystal cell (B1, 2), the data line D2 is formed along two sides of the liquid crystal cell. On the other hand, as for the liquid crystal cell (R1, 1) and the liquid crystal cell (R2, 3), the data line D2 is formed along only one side of the liquid crystal cell. Therefore, the former liquid crystal cell and the latter liquid crystal cell are different in coupling capacitance with respect to the data line.

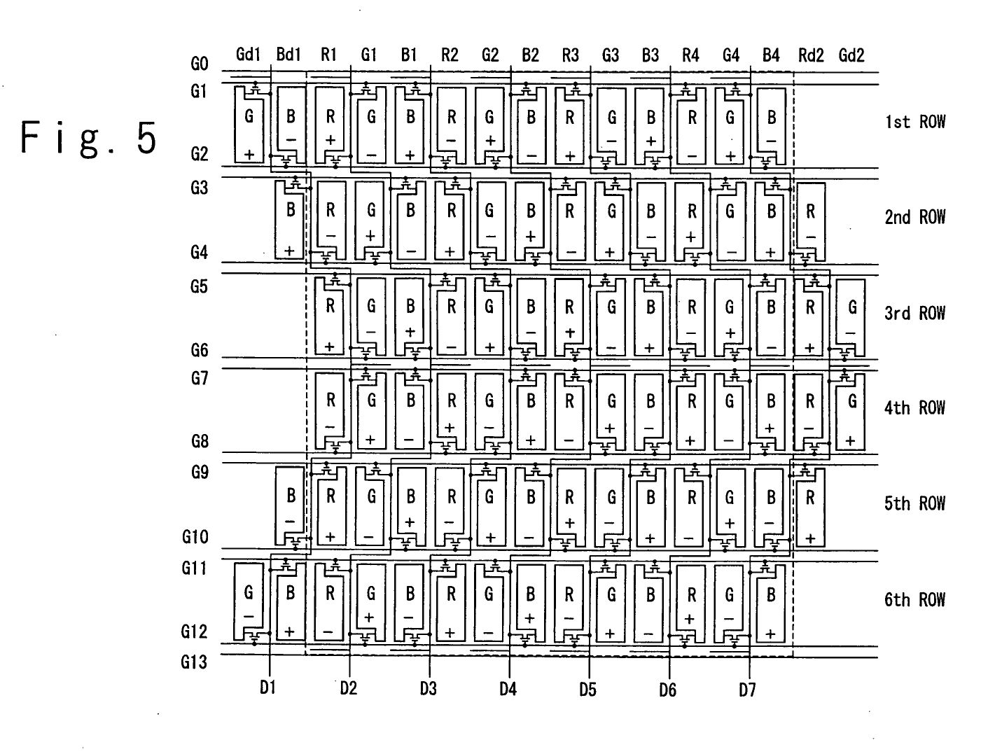

In the 2nd arrangement example, the above-mentioned difference in the coupling capacitance is eliminated. FIG. 5 shows the 2nd arrangement example, which is a modification example of FIG. 2. According to the 2nd arrangement example, a dummy line is added to the data line in order to equalize the coupling capacitance between the data line and each liquid crystal cell. Specifically, the dummy line is added to a section where the data line does not meander in the 0-th row (virtual), the 1st row, the 3rd row, the 4th row, the 6th row and the 7th row (the 1st row in the second block). Moreover, a dummy scanning line G0 is provided in parallel to the scanning line G1 in order to equalize influence of coupling capacitance between the dummy line in the 1st row and the gate line. The dummy scanning line is added to both the top and bottom of one liquid crystal panel.

### 3rd Arrangement Example

FIG. 6 shows the 3rd arrangement example, which is one of variations of FIG. 2. The 3rd arrangement example is different from FIG. 2 in that one block includes liquid crystal cells of twelve columns×twelve rows and the TFT position is opposite with regard to the liquid crystal cells in half of the rows (i.e. the 2nd row, the 3rd row, the 6th row, the 7th row, the 10th row and the 11th row). According to the 3rd arrangement example, 2H1V dot inversion pattern can be achieved even when the voltage polarity of the data signal is inverted every 1 G period.

Regarding four liquid crystal cells (R1, 2), (G1, 2), (B1, 2) and (R2, 2) in the 2nd row, the liquid crystal cells (R1, 2) and (G1, 2) are connected to the scanning line G3 and the liquid crystal cells (B1, 2) and (R2, 2) are connected to the scanning line G4. Regarding four liquid crystal cells (R1, 3), (G1, 3), (B1, 3) and (R2, 3) in the 3rd row, the liquid crystal cells (G1, 3) and (B1, 3) are connected to the scanning line G5 and the liquid crystal cells (R1, 3) and (R2, 3) are connected to the scanning line G6. Regarding four liquid crystal cells (R1, 6), (G1, 6), (B1, 6) and (R2, 6) in the 6th row, the liquid crystal cells (G1, 6) and (B1, 6) are connected to the scanning line G11 and the liquid crystal cells (R1, 6) and (R2, 6) are connected to the scanning line G12.

A hatching section in FIG. 6 indicates the liquid crystal cells connected to the data line D2. As for the 1st to 6th rows, the colors and the polarities of the data signals supplied to the liquid crystal cells (R1, 1), (G1, 1), (G1, 2), (B1, 2), . . . , (R1, 6) and (G1, 6) connected to the data line D2 are as follows. The data line driver circuit supplies the [G, negative]-signal, the [R, positive]-signal, the [G, negative]-signal, the [B, positive]-signal, the [B, negative]-signal and the [R, positive]-signal in this order to the liquid crystal cells (G1, 1), (R1, 1), (G1, 2), (B1, 2), (B1, 3) and (R2, 3) connected to the scanning lines G1 to G6, respectively. Also, the data line driver circuit supplies the [B, negative]-signal, the [R, positive]-signal, the [G, negative]-signal, the [B, positive]-signal, the [G, negative]-signal and the [R, positive]-signal in this order to the liquid crystal cells (B1, 4), (R2, 4), (G1, 5), (B1, 5), (G1, 6) and (R1, 6) connected to the scanning lines G7 to G12, respectively.

Regarding four liquid crystal cells (R1, 7), (G1, 7), (B1, 7) and (R2, 7) in the 7th row, the liquid crystal cells (R1, 7) and (R2, 7) are connected to the scanning line G13 and the liquid crystal cells (G1, 7) and (B1, 7) are connected to the scanning line G14. Regarding four liquid crystal cells (R1, 10), (G1, 10), (B1, 10) and (R2, 10) in the 10th row, the liquid crystal cells (R1, 10) and (R2, 10) are connected to the scanning line G19 and the liquid crystal cells (G1, 10) and (B1, 10) are connected to the scanning line G20. Regarding four liquid crystal cells (R1, 11), (G1, 11), (B1, 11) and (R2, 11) in the 11th row, the liquid crystal cells (B1, 11) and (R2, 11) are connected to the scanning line G21 and the liquid crystal cells (R1, 11) and (G1, 11) are connected to the scanning line G22.

As for the 7th to 12th rows, the colors and the polarities of the data signals supplied to the liquid crystal cells (R1, 7), (G1, 7), (G1, 8), (B1, 8), . . . , (R1, 12) and (G1, 12) connected to the data line D2 are as follows. The data line driver circuit supplies the [R, negative]-signal, the [G, positive]-signal, the [B, negative]-signal, the [G, positive]-signal, the [R, negative]-signal and the [B, positive]-signal in this order to the liquid crystal cells (R1, 7), (G1, 7), (B1, 8), (G1, 8), (R2, 9) and (B1, 9) connected to the scanning lines G13 to G18, respectively. Also, the data line driver circuit supplies the [R, negative]-signal, the [B, positive]-signal, the [B, negative]-signal, the [G, positive]-signal, the [R, negative]-signal and the [G, positive]-signal in this order to the liquid crystal cells (R2, 10), (B1, 10), (B1, 11), (G1, 11), (R1, 12) and (G1, 12) connected to the scanning lines G19 to G24, respectively.

Regarding one block from the 1st to 12th rows, each of the six kinds of data signals is supplied to the data line D2 for four times during the 12 H period. The same applies to the other data lines. Each of the six kinds of data signals is supplied for the same number of times (four times) to each data line during the 12 H period when the one block is driven.

The reason why the one block is designed to have twelve rows is to avoid succession of the same polarity over four rows. For example, in the case of the column R1 in FIG. 6, the voltage polarities of the liquid crystal cells from the 1st row to the 12th row are “+ + − − + + − − + + − −”. In the case of the column G1, the voltage polarities of the liquid crystal cells from the 1st row to the 12th row are “− −+ + − − + + − − + +”. If one block consists of six rows and a polarity pattern “− − + + − −” appears repeatedly in the vertical direction, a polarity pattern of vertical two blocks becomes “− − + + − − − − + + − −”, namely the same polarity appears over four successive rows.

In the 3rd arrangement example, the TFT position of the liquid crystal cell is modified. Accordingly, the 2H1V dot inversion pattern can be achieved even when the voltage polarity of the data signal is inverted every 1 G period.

### 4th Arrangement Example

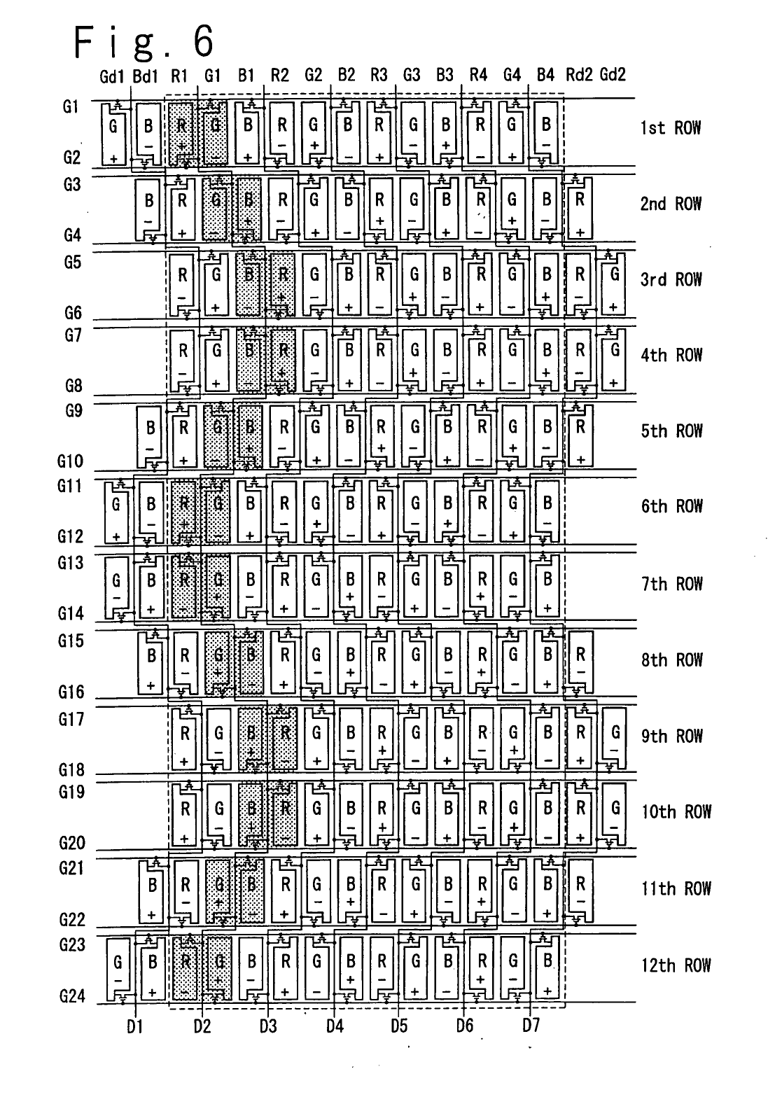

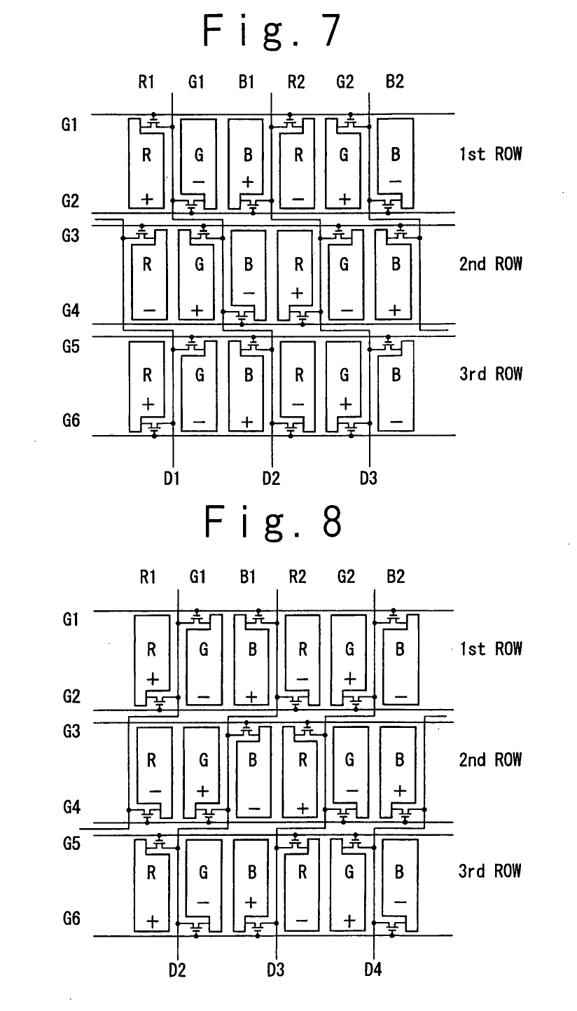

FIG. 7 shows an example where the TFT position of the liquid crystal cell is opposite to that in the case of FIG. 2. In the 1st row, the liquid crystal cell (R1, 1), the liquid crystal cell (R2, 1) and the liquid crystal cell (G2, 1) are connected to the scanning line G1, and the liquid crystal cell (G1, 1), the liquid crystal cell (B1, 1) and the liquid crystal cell (B2, 1) are connected to the scanning line G2. In the 2nd row, the liquid crystal cell (R1, 2), the liquid crystal cell (G1, 2), the liquid crystal cell (G2, 2) and the liquid crystal cell (B2, 2) are connected to the scanning line G3, and the liquid crystal cell (B1, 2) and the liquid crystal cell (R2, 2) are connected to the scanning line G4. In the 3rd row, the liquid crystal cell (G1, 3), the liquid crystal cell (B1, 3) and the liquid crystal cell (B2, 3) are connected to the scanning line G5, and the liquid crystal cell (R1, 3), the liquid crystal cell (R2, 3) and the liquid crystal cell (G2, 3) are connected to the scanning line G6.

### 5th Arrangement Example

FIG. 8 shows an example where the meandering direction is the opposite as compared with the example shown in FIG. 2. In the 1st row, the liquid crystal cell (B1, 1) and the liquid crystal cell (R2, 1) are connected to the data line D2, and the liquid crystal cell (B2, 1) and the liquid crystal cell (G2, 1) are connected to the data line D3. In the 2nd row, the liquid crystal cell (B1, 2) and the liquid crystal cell (G1, 2) are connected to the data line D2, and the liquid crystal cell (R2, 2) and the liquid crystal cell (G2, 2) are connected to the data line D3. In the 3rd row, the liquid crystal cell (R1, 3) and the liquid crystal cell (G1, 3) are connected to the data line D2, and the liquid crystal cell (R2, 3) and the liquid crystal cell (B1, 3) are connected to the data line D3.

The colors and the polarities of the data signals supplied to the liquid crystal cells connected to the data line D2 are as follows. The [B, positive]-signal, the [R, negative]-signal, the [B, negative]-signal, the [G, positive]-signal, the [R, positive]-signal and the [G, negative]-signal are supplied in this order to the liquid crystal cells (B1, 1), (R2, 1), (B1, 2), (G1, 2), (R1, 3) and (G1, 3), respectively. The colors and the polarities of the data signals supplied to the liquid crystal cells connected to the data line D3 are as follows. The [B, negative]-signal, the [G, positive]-signal, the [R, positive]-signal, the [G, negative]-signal, the [R, negative]-signal and the [B, positive]-signal are supplied in this order to the liquid crystal cells (B2, 1), (G2, 1), (R2, 2), (G2, 2), (R2, 3) and (B1, 3), respectively.

### 6th Arrangement Example

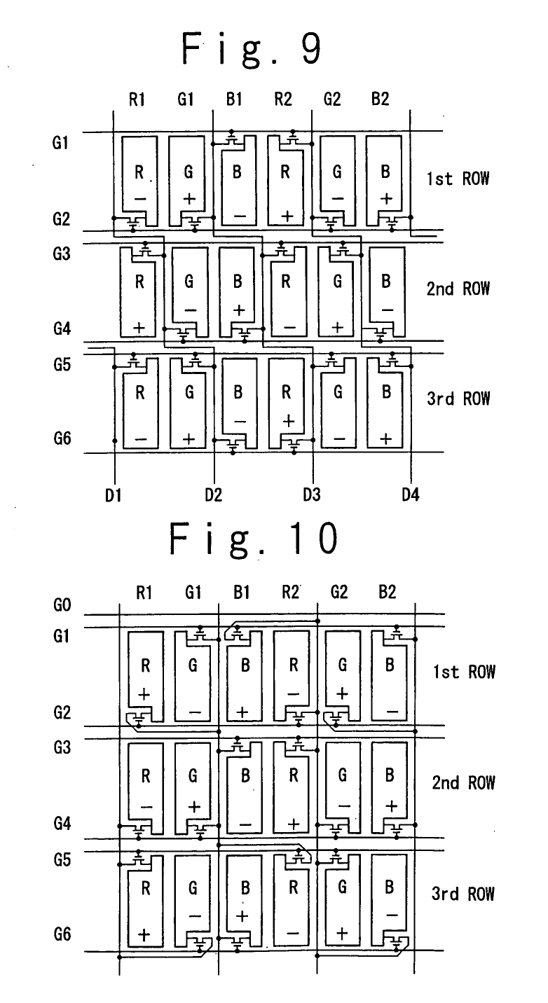

FIG. 9 shows an example where a combination of liquid crystal cells sharing one data line is different. In each block, one data line is added and two dummy columns are added. In the 1st row, the liquid crystal cell (Bd1, 1) (not shown) and the liquid crystal cell (R1, 1) are connected to the data line D2, and the liquid crystal cell (G1, 1) and the liquid crystal cell (B1, 1) are connected to the data line D3. In the 2nd row, the liquid crystal cell (R1, 2) and the liquid crystal cell (G1, 2) are connected to the data line D2, and the liquid crystal cell (B1, 2) and the liquid crystal cell (R2, 2) are connected to the data line D3. In the 3rd row, the liquid crystal cell (G1, 3) and the liquid crystal cell (B1, 3) are connected to the data line D2, and the liquid crystal cell (R2, 3) and the liquid crystal cell (G2, 3) are connected to the data line D3.

The colors and the polarities of the data signals supplied to the liquid crystal cells connected to the data line D2 are as follows. The [B, positive]-signal (not shown), the [R, negative]-signal, the [R, positive]-signal, the [G, negative]-signal, the [G, positive]-signal and the [B, negative]-signal are supplied in this order to the liquid crystal cells (Bd1, 1), (R1, 1), (R1, 2), (G1, 2), (G1, 3) and (B1, 3), respectively. The colors and the polarities of the data signals supplied to the liquid crystal cells connected to the data line D3 are as follows. The [B, negative]-signal, the [G, positive]-signal, the [R, negative]-signal, the [B, positive]-signal, the [G, negative]-signal and the [R, positive]-signal are supplied in this order to the liquid crystal cells (B1, 1), (G1, 1), (R2, 2), (B1, 2), (G2, 3) and (R2, 3), respectively.

### 7th Arrangement Example

FIG. 10 shows an example where the data line does not meander. In the 1st row, the liquid crystal cell (R1, 1) and the liquid crystal cell (G1, 1) are connected to the data line D2, and the liquid crystal cell (B1, 1) and the liquid crystal cell (R2, 1) are connected to the data line D3. In the 2nd row, the liquid crystal cell (G1, 2) and the liquid crystal cell (B1, 2) are connected to the data line D2, and the liquid crystal cell (R2, 2) and the liquid crystal cell (G2, 2) are connected to the data line D3. In the 3rd row, the liquid crystal cell (B1, 3) and the liquid crystal cell (R2, 3) are connected to the data line D2, the liquid crystal cell (G2, 3) and the liquid crystal cell (B2, 3) are connected to the data line D3.

The colors and the polarities of the data signals supplied to the liquid crystal cells connected to the data line D2 are as follows. The [G, negative]-signal, the [R, positive]-signal, the [B, negative]-signal, the [G, positive]-signal, the [R, negative]-signal and the [B, positive]-signal are supplied in this order to the liquid crystal cells (G1, 1), (R1, 1), (B1, 2), (G1, 2), (R2, 3) and (B1, 3), respectively. The colors and the polarities of the data signals supplied to the liquid crystal cells connected to the data line D3 are as follows. The [B, positive]-signal, the [R, negative]-signal, the [R, positive]-signal, the [G, negative]-signal, the [G, positive]-signal and the [B, negative]-signal are supplied in this order to the liquid crystal cells (B1, 1), (R2, 1), (R2, 2), (G2, 2), (G2, 3) and (B2, 3), respectively.

### 8th Arrangement Example

In one block, the data line may meander in the following manner. Here, L is 0 or a natural number and K=3 L+2. The data line may shift in the right direction by one liquid crystal cell for K times, then remain unshifted for one time, then shift in the left direction by one liquid crystal cell for K times, then remain unshifted for one time. However, if K is large, the reordering of the image data by the signal control unit 10 becomes complicated. Therefore, the case of K=2 is preferable for the signal control unit 10. Moreover, the case of K=2 is preferable from a view point of suppressing the number of dummy columns.

As another meandering pattern, the data line may extend in the vertical direction by two liquid crystal cells, then shift to the right by one liquid crystal cell between the 2nd and 3rd rows and between the 4th and 5th rows, and then shift to the left by one liquid crystal cell between the 8th and 9th rows and between the 10th and 11th rows.

### Second Embodiment

In the second embodiment, one pixel includes a liquid crystal cell W (white color, white) in addition to the liquid crystal cells RGB and has a 2×2 arrangement of the four colors (RGBW). The liquid crystal cell W means a liquid crystal cell having no color filter. Since light transmission is high due to no color filter, brightness of the white backlight can be lowered to achieve low power consumption.

Let us consider the WXGA (1280×768 pixels). The first direction is the vertical direction, and the second direction is the horizontal direction. The vertical number of effective liquid crystal cells in the first direction is 1536 (=768×2), and the horizontal number of effective liquid crystal cells in the second direction is 2560 (=1280×2). Since one row is provided with two scanning lines in the liquid crystal panel 2, the number of scanning lines is 3072 which is twice the vertical number of effective liquid crystal cells. Since one data line is shared by adjacent liquid crystal cells, the number of data lines is 1280 which is half the horizontal number of effective liquid crystal cells. According to the present embodiment, each of eight kinds of data signals is supplied for the same number of times to each data line during a predetermined period when one block is driven.

### 9th Arrangement Example

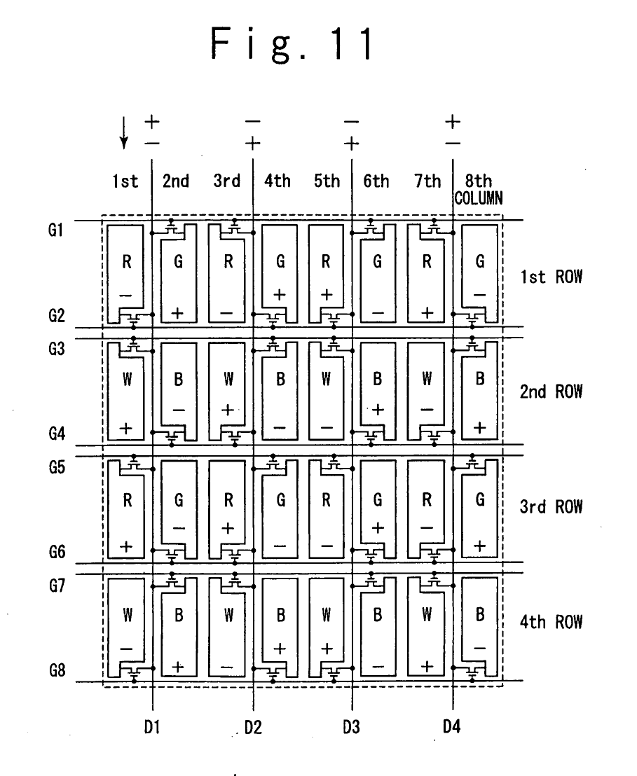

The 9th arrangement example will be described below with reference to FIG. 11. In the 9th arrangement example, one pixel has a 2×2 arrangement of the liquid crystal cells R, G in an odd-numbered row and the liquid crystal cells B, W in an even-numbered row. The four liquid crystal cells constituting one pixel are all connected to the same data line. In the 9th arrangement example, the rows of the liquid crystal cells are referred to as the 1st column, the 2nd column, . . . , the 8th column from the left. In order to distinguishing the liquid crystal cells, for example, a liquid crystal cell in the 3rd column and 2nd row is referred to as a liquid crystal cell (3, 2). In FIG. 11, the liquid crystal cell (1, 1) is R (red color, red), the liquid crystal cell (2, 1) is G (green color, green), the liquid crystal cell (1, 2) is W (white color, white) and the liquid crystal cell (2, 3) is B (blue color, blue). Needless to say, the color arrangement is not limited to that.

A connection relationship between the scanning lines and the liquid crystal cells in FIG. 11 is as follows. In the 1st row, the liquid crystal cell (2, 1), the liquid crystal cell (3, 1), the liquid crystal cell (6, 1) and the liquid crystal cell (7, 1) are connected to the scanning line G1, and the liquid crystal cell (1, 1), the liquid crystal cell (4, 1), the liquid crystal cell (5, 1) and the liquid crystal cell (8, 1) are connected to the scanning line G2. In the 2nd row, the liquid crystal cell (1, 2), the liquid crystal cell (4, 2), the liquid crystal cell (5, 2) and the liquid crystal cell (8, 2) are connected to the scanning line G3, and the liquid crystal cell (2, 2), the liquid crystal cell (3, 2), the liquid crystal cell (6, 2) and the liquid crystal cell (7, 2) are connected to the scanning line G4. The 3rd row is similar to the 2nd row, and the 4th row is similar to the 1st row.

A connection relationship between the data lines and the liquid crystal cells is as follows. The liquid crystal cells (2, 1), (1, 1), (1, 2), (2, 2), (1, 3), (2, 3), (2, 4) and (1, 4) are connected to the data line D1. The liquid crystal cells (3, 1), (4, 1), (4, 2), (3, 2), (4, 3), (3, 3), (3, 4) and (4, 4) are connected to the data line D2. The data line D3 is similar to the data line D1, and the data line D4 is similar to the data line D2.

The voltage polarity of the data signal supplied to each data line is inverted every 1 G period. The data lines D1 and D4 are the same in the voltage polarity. The data lines D2 and D3 are opposite in the voltage polarity to the data lines D1 and D4. In FIG. 11, the voltage polarities of the data signals supplied to each of the data lines D1 and D4 are “+ − + − + − + −”, and the voltage polarities of the data signals supplied to each of the data lines D2 and D3 is “− + − + − + − +”. The voltage polarity of each liquid crystal cell is inverted every one frame. In the 9th arrangement example, eight kinds of data signals (the four colors and the two polarities) are supplied to each data line. Therefore, the vertical crosstalk can be suppressed as in the case of FIG. 2. Regarding the six kinds of data signals (RGB and the two polarities), each of the six kinds of data signals is supplied for the same number of times to each data line during a predetermined period when the one block is driven, also in the 9th arrangement example.

In the 9th arrangement example, the voltage polarity is the same between the liquid crystal cells in the 4th column and the 5th column and between the liquid crystal cells in the 8th column and the 9th column, which is not the dot inversion pattern. However, it is equivalent to the 1H2V dot inversion pattern, when attention is paid to only the same color.

One row includes liquid crystal cells of two colors. With regard to one row, four liquid crystal cells are selected in one scanning period: a first liquid crystal cell to which the [first color, positive polarity]-signal is supplied; a second liquid crystal cell to which the [first color, negative polarity]-signal is supplied; a third liquid crystal cell to which the [second color, positive polarity]-signal is supplied; and a fourth liquid crystal cell to which the [second color, negative polarity]-signal is supplied. Therefore, the horizontal crosstalk can be suppressed, as in the case of FIG. 2.

According to the 9th arrangement example, as described above, each of 2K kinds of data signals (combinations of K kinds of colors and the two polarities) is supplied for the same number of times to each data line during a predetermined period. Therefore, the vertical crosstalk can be suppressed even in the case of the double scanning line method.

### Third Embodiment

The third embodiment proposes a technique to improve the crosstalk in the above-mentioned Patent Document 4. Let us consider the WXGA (1280×768 pixels) having an RGB horizontal stripe arrangement. The first direction is the horizontal direction, and the second direction is the vertical direction. The horizontal number of effective liquid crystal cells in the first direction is 1280, and the vertical number of effective liquid crystal cells in the second direction is 2304 (=768×3). In the liquid crystal display device 1 of the present embodiment, one column is provided with two data lines. A total number of data lines is 2560 which is twice the horizontal number of effective liquid crystal cells. According to the present embodiment, each of the six kinds of data signals is supplied for the same number of times to each data line during a predetermined period when one block is driven.

### 10th Arrangement Example

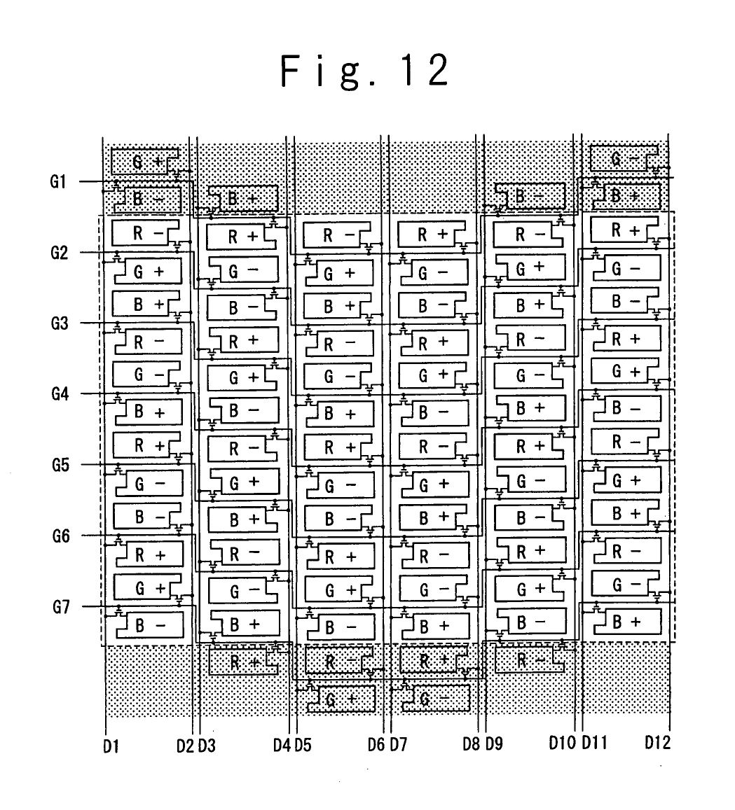

FIG. 12 shows an arrangement of the liquid crystal cells, the data lines and the scanning lines in the 10th arrangement example. In the 10th arrangement example, as shown, one scanning line is shared by two adjacent liquid crystal cells. Therefore, a total number of scanning lines is 1153 (=1152+1=half the vertical number of effective liquid crystal cells +1). Moreover, each scanning line is formed to meander (snake). One block includes the liquid crystal cells of 6 columns×12 rows surrounded by a dashed line. There are 214×192 blocks as a whole in the case of WXGA. For simplicity, dummy liquid crystal cells (hatching section) are shown on the top and bottom of first block. The dummy liquid crystal cell is shaded.

In order to distinguishing the liquid crystal cells within the block surrounded by the dashed line, for example, the liquid crystal cells in the 1st column are referred to as liquid crystal cells (1, R1), (1, G1), (1, B1), (1, R2), (1, G2), (1, B2) . . . , as in the above-described arrangement example.

Regarding the block surrounded by the dashed line in FIG. 12, a connection relationship between the liquid crystal cells in the 1st column and the data lines D1, D2 is as follows. The liquid crystal cells (1, G1), (1, R2), (1, B2), (1, G3), (1, R4) and (1, B4) are connected to the data line D1. The liquid crystal cells (1, R1), (1, B1), (1, G2), (1, R3), (1, B3) and (1, G4) are connected to the data line D2.

A connection relationship between the liquid crystal cells in the 1st column and the scanning lines G2 to G7 is as follows. The liquid crystal cell (1, R1) and the liquid crystal cell (1, G1) are connected to the scanning line G2. The liquid crystal cell (1, B1) and the liquid crystal cell (1, R2) are connected to the scanning line G3. The liquid crystal cell (1, G2) and the liquid crystal cell (1, B2) are connected to the scanning line G4. The liquid crystal cell (1, R3) and the liquid crystal cell (1, G3) are connected to the scanning line G5.

In a period when the block surrounded by the dashed line in FIG. 12 is driven, the colors and the polarities of the data signals supplied to the liquid crystal cells (1, G1), (1, R2), (1, B2), (1, G3), (1, R4) and (1, B4) connected to the data line D1 are as follows. As shown, the data line driver circuit supplies the [G, positive]-signal, the [R, negative]-signal, the [B, positive]-signal, the [G, negative]-signal, the [R, positive]-signal and the [B, negative]-signal in this order to the data line D1. In the period when the same block is driven, the colors and the polarities of the data signals supplied to the liquid crystal cells (1, R1), (1, B1), (1, G2), (1, R3), (1, B3) and (1, G4) connected to the data line D2 are as follows. As shown, the data line driver circuit supplies the [R, negative]-signal, the [B, positive]-signal, the [G, negative]-signal, the [R, positive]-signal, the [B, negative]-signal and the [G, positive]-signal in this order to the data line D2.

In this manner, the six kinds of data signals are supplied to the pixels. It is thus possible to suppress variation in the common voltage depending on the color.

The following arrangement examples (the 11th to 18th arrangement examples) are other examples for improving the crosstalk in the above-mentioned Patent Document 4. Let us consider the WXGA (1280×768 pixels) having the RGB horizontal stripe arrangement. The first direction is the horizontal direction, and the second direction is the vertical direction. The horizontal number of effective liquid crystal cells in the first direction is 1280, and the vertical number of effective liquid crystal cells in the second direction is 2304 (=768×3). In the liquid crystal display device 1, one column is provided with two data lines. A total number of data lines is 2560 which is twice the horizontal number of effective liquid crystal cells. A total number of scanning lines is 2304 which is equal to the vertical number of effective liquid crystal cells excluding the dummy liquid crystal cells.

### 11th Arrangement Example

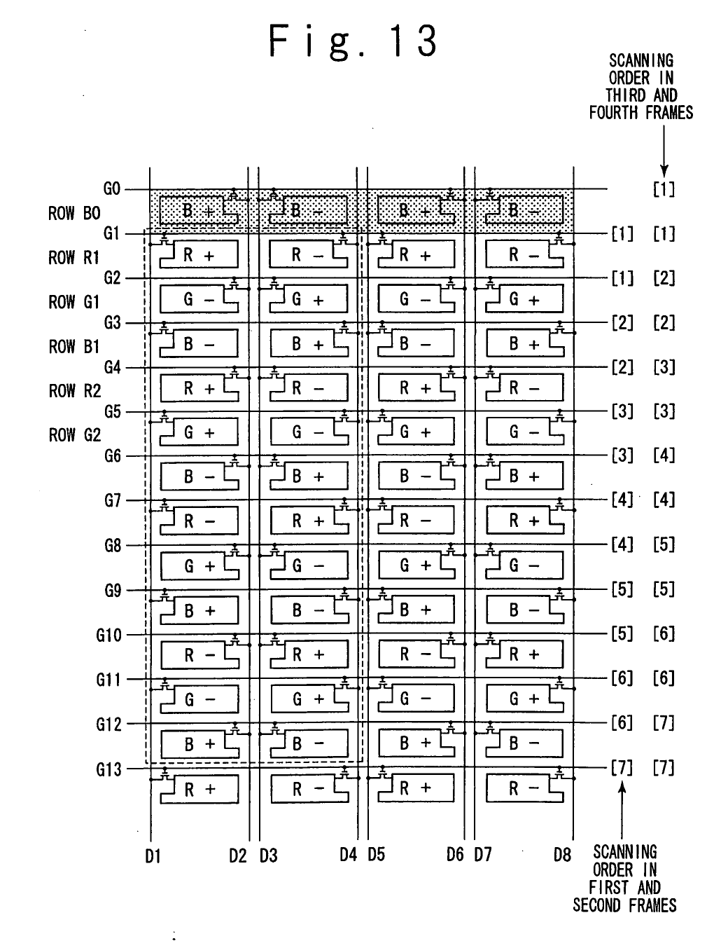

FIG. 13 shows an arrangement of the liquid crystal cells, the data lines and the scanning lines in the 11th arrangement example. According to the present arrangement example, the scanning line driver circuit drives two scanning lines concurrently in the 1 G period. Moreover, the scanning line driver circuit changes the scanning order every two frames. One block includes the liquid crystal cells of 2 columns×12 rows surrounded by a dashed line.

Regarding the block surrounded by the dashed line in FIG. 13, a connection relationship between the liquid crystal cells in the 1st column and the data lines D1, D2 is as follows. The liquid crystal cells (1, R1), (1, B1), (1, G2), (1, R3), (1, B3) and (1, G4) are connected to the data line D1. The liquid crystal cells (1, G1), (1, R2), (1, B2), (1, G3), (1, R4) and (1, B4) are connected to the data line D2.

A connection relationship between the liquid crystal cells in the 1st column and the scanning lines G1 to G12 is as follows. The liquid crystal cell (1, R1) is connected to the scanning line G1, the liquid crystal cell (1, G1) is connected to the scanning line G2, and the liquid crystal cell (1, B1) is connected to the scanning line G3. The liquid crystal cell (1, R2) is connected to the scanning line G4, the liquid crystal cell (1, G2) is connected to the scanning line G5, and the liquid crystal cell (1, B2) is connected to the scanning line G6. The liquid crystal cell (1, R3) is connected to the scanning line G7, the liquid crystal cell (1, G3) is connected to the scanning line G8, and the liquid crystal cell (1, B3) is connected to the scanning line G9. The liquid crystal cell (1, R4) is connected to the scanning line G10, the liquid crystal cell (1, G4) is connected to the scanning line G11, and the liquid crystal cell (1, B4) is connected to the scanning line G12.

In a period when the block surrounded by the dashed line is driven, the colors and the polarities of the data signals supplied to the liquid crystal cells (1, R1), (1, B1), (1, G2), (1, R3), (1, B3) and (1, G4) connected to the data line D1 are as follows. As shown, the data line driver circuit supplies the [R, positive]-signal, the [B, negative]-signal, the [G, positive]-signal, the [R, negative]-signal, the [B, positive]-signal and the [G, negative]-signal in this order to the data line D1. In the period when the same block is driven, the colors and the polarities of the data signals supplied to the liquid crystal cells (1, G1), (1, R2), (1, B2), (1, G3), (1, R4) and (1, B4) connected to the data line D2 are as follows. As shown, the data line driver circuit supplies the [G, negative]-signal, the [R, positive]-signal, the [B, negative]-signal, the [G, positive]-signal, the [R, negative]-signal and the [B, positive]-signal in this order to the data line D2.

FIG. 14 shows change in the voltage polarity in the case where the scanning order is changed in response to frame switching. In the 11th arrangement example, the scanning lines are driven two by two, and the scanning order is changed every two frames. As shown in FIG. 14, in the first and second frames, the scanning line G1 and the scanning line G2 are concurrently selected in the first scanning period, the scanning line G3 and the scanning line G4 are concurrently selected in the second scanning period, and the scanning line G5 and the scanning line G6 are concurrently selected in the third scanning period. On the other hand, in the third and fourth frames, the scanning line G0 and the scanning line G1 are concurrently selected in the first scanning period, the scanning line G2 and the scanning line G3 are concurrently selected in the second scanning period, and the scanning line G4 and the scanning line G5 are concurrently selected in the third scanning period.

The polarities of the data signals supplied to the liquid crystal cells during the first frame are the same as in the case of FIG. 13. As shown in FIG. 14, in the second frame, the [R, negative]-signal, the [B, positive]-signal and the [G, negative]-signal are supplied in this order respectively to the liquid crystal cells (1, R1), (1, B1) and (1, G2) connected to the data line D1 in the 1st column, and the [G, positive]-signal and the [R, negative]-signal are supplied in this order respectively to the liquid crystal cells (1, G1) and (1, R2) connected to the data line D2 in the 1st column. In the third frame, the [R, positive]-signal, the [B, negative]-signal and the [G, positive]-signal are supplied in this order respectively to the liquid crystal cells (1, R1), (1, B1) and (1, G2) connected to the data line D1 in the 1st column, and the [B, positive]-signal, the [G, negative]-signal and the [R, positive]-signal are supplied in this order respectively to the liquid crystal cells (1, B0), (1, G1) and (1, R2) connected to the data line D2 in the 1st column. In the fourth frame, the [R, negative]-signal, the [B, positive]-signal and the [G, negative]-signal are supplied in this order respectively to the liquid crystal cells (1, R1), (1, B1) and (1, G2) connected to the data line D1 in the 1st column, and the [B, negative]-signal, the [G, positive]-signal and the [R, negative]-signal are supplied in this order respectively to the liquid crystal cells (1, B0), (1, G1) and (1, R2) connected to the data line D2 in the 1st column.

For example, let us focus on the first scanning period (indicated by [1] in FIG. 14) in each frame. The row R1 and the row G1 are concurrently selected in the first and second frames, and the row B0 (dummy) and the row R1 are selected in the third and fourth frames. That is, the row R1 is affected by the blue color of the row B0 in the third and fourth frames and affected by the green color of the row G1 in the first and second frames. The same applies to the other rows. It is therefore possible according to the 11th arrangement example to average bias of the crosstalk depending on color.

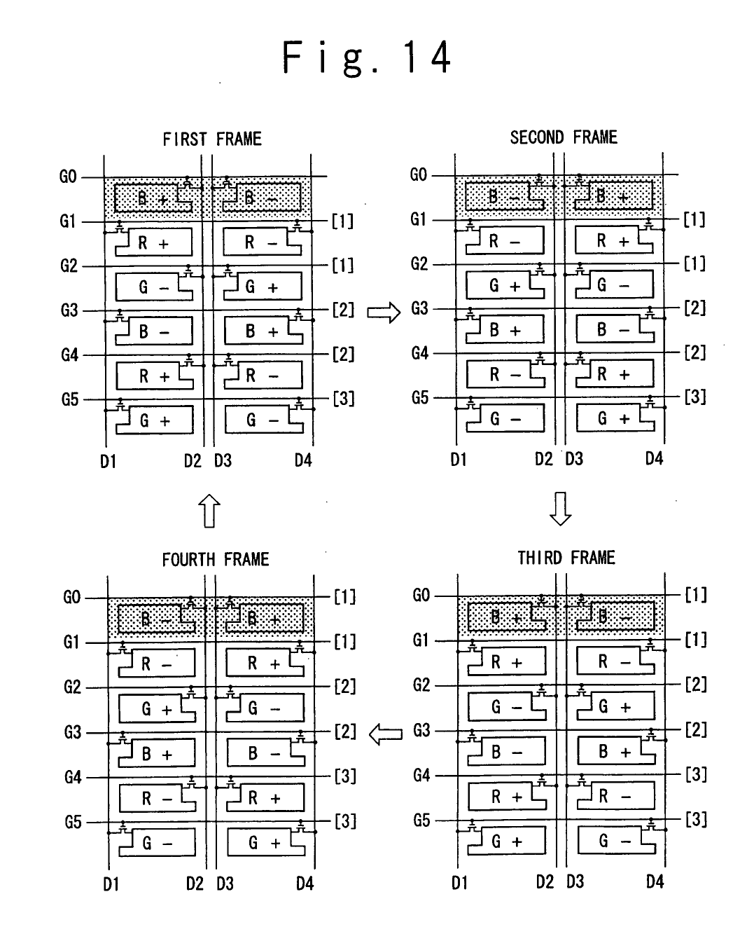

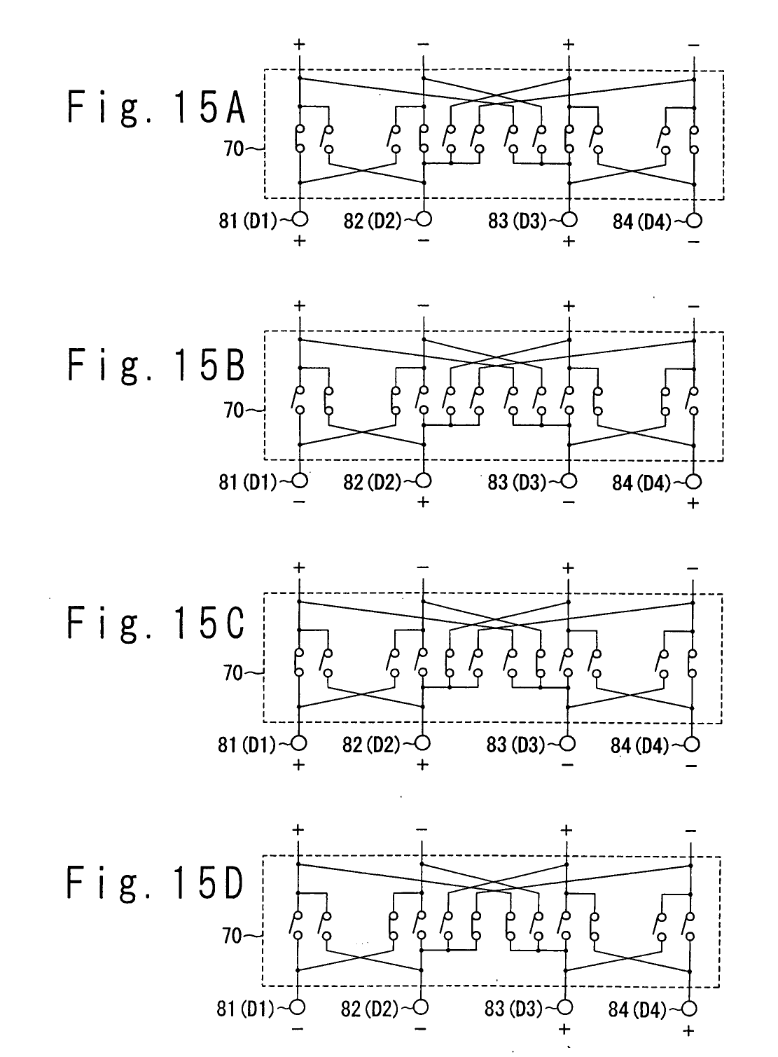

FIGS. 15A to 15D show the polarity switch unit 70 in the data line driver circuit according to the present example. Specifically, FIGS. 15A to 15D illustrate switch states in the reordering of the data signals having the polarities “+ − + −” generated by the D/A conversion. FIG. 15A illustrates a switch state (state-A) when outputting the data signals having the polarities “+ − + −” respectively to the data lines D1, D2, D3 and D4. FIG. 15B illustrates a switch state (state-B) when outputting the data signals having the polarities “− + − +” respectively to the data lines D1, D2, D3 and D4. FIG. 15C illustrates a switch state (state-C) when outputting the data signals having the polarities “+ + − −” respectively to the data lines D1, D2, D3 and D4. FIG. 15D illustrates a switch state (state-D) when outputting the data signals having the polarities “− − + +” respectively to the data lines D1, D2, D3 and D4. The polarity switch unit 70 in the 11th arrangement example switches between the state-A and the state-B every one scanning period during the first and second frames, and also switches between the state-C and the state-D every one scanning period during the third and fourth frame.

### 12th Arrangement Example

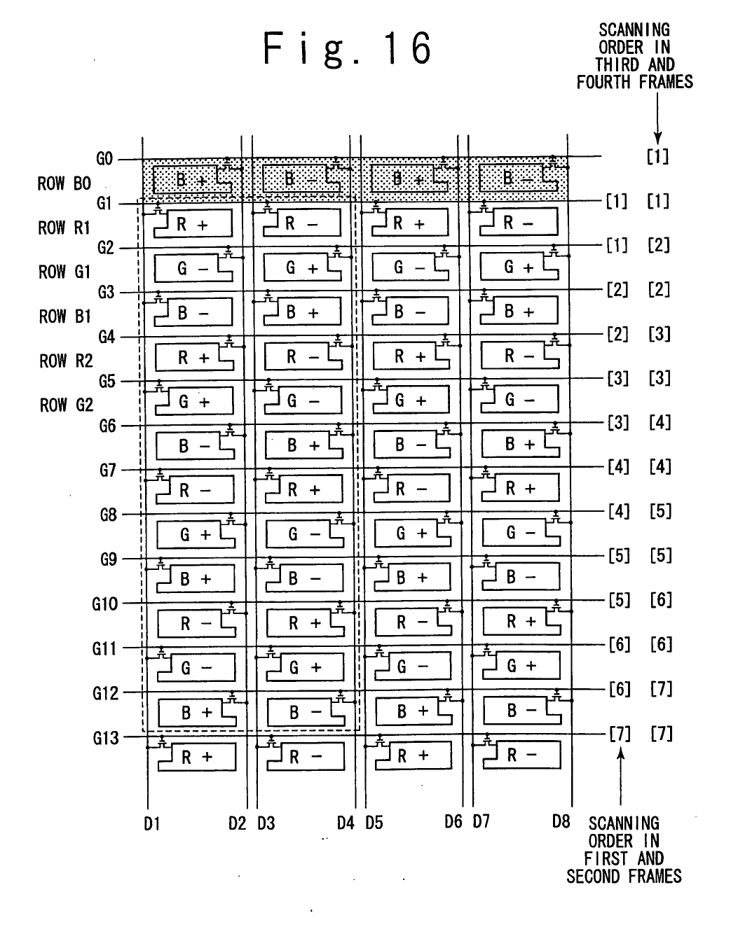

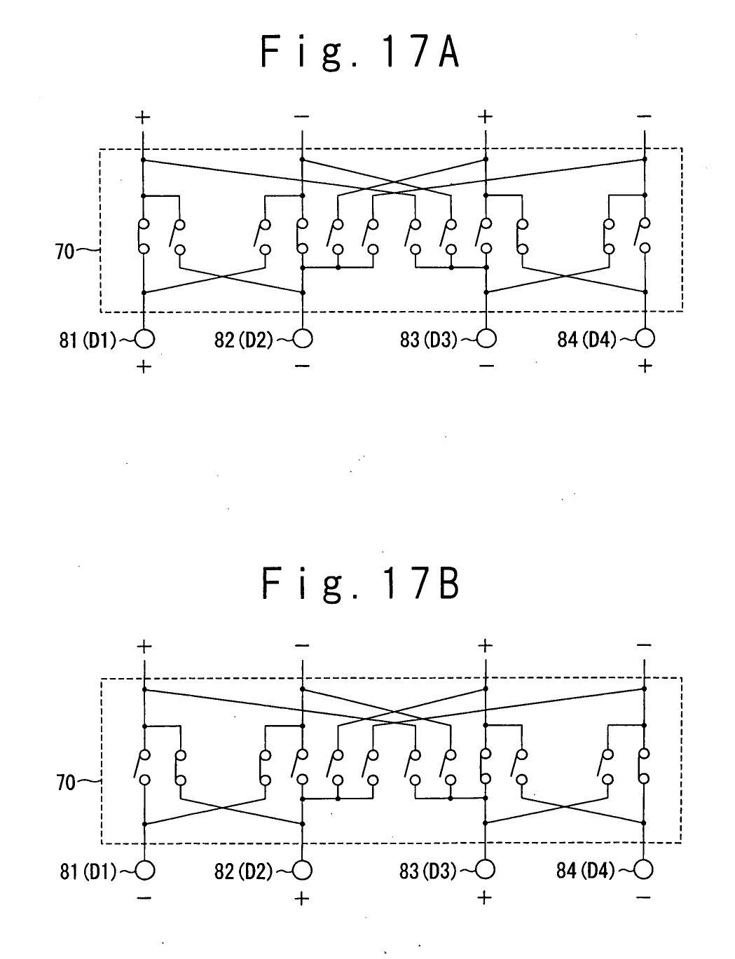

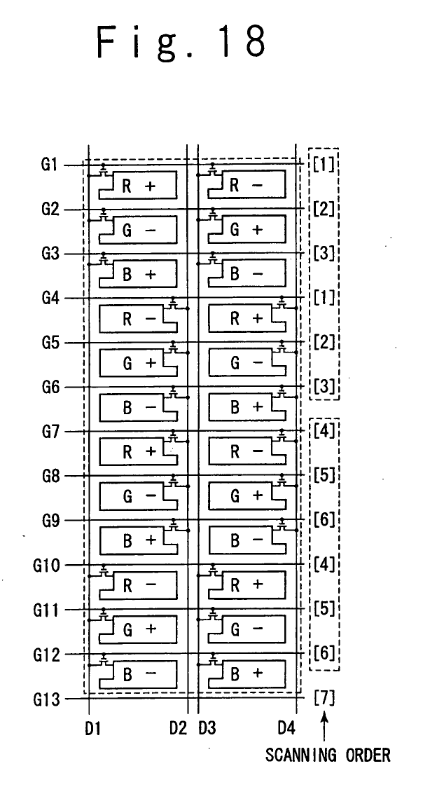

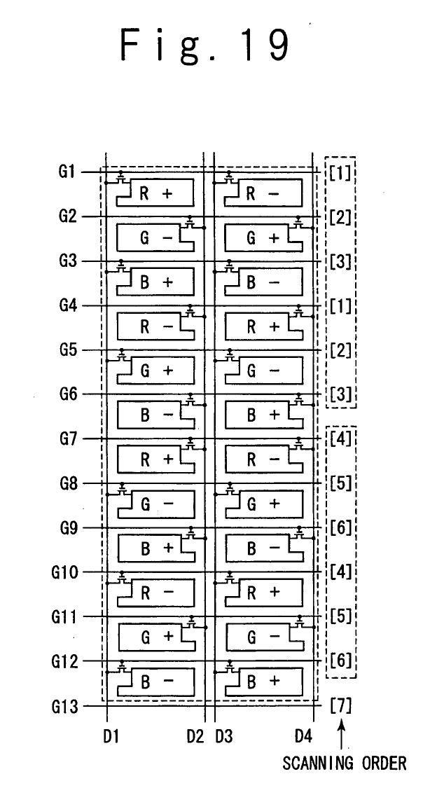

FIG. 16 shows the 12th arrangement example. With regard to the 2 columns×12 rows block surrounded by a dashed line, the example shown in FIG. 16 is different from that of FIG. 13 in that the TFT position in the 2nd column is changed. FIGS. 17A and 17B show the polarity switch unit 70 in the data line driver circuit according to the present example. FIG. 17A illustrates a switch state (state-E) when outputting the data signals having the polarities “+ − − +” respectively to the data lines D1, D2, D3 and D4. FIG. 17B illustrates a switch state (state-F) when outputting the data signals having the polarities “− + + −” respectively to the data lines D1, D2, D3 and D4.

According to the present arrangement example shown in FIG. 16, the polarity switch unit 70 switches between the state-E and the state-F every one scanning period during the first and second frames, and also switches between the state-C and the state-D every one scanning period during the third and fourth frame. If the parasitic capacitance between the data lines D2 and D3 is large and the voltage polarity of the data signal is different between the data lines D2 and D3, consumption current of the parasitic capacitance is increased. Therefore, in the present arrangement example, the data signals of the same polarity are supplied to the data lines D2 and D3 in order to reduce the consumption current. The block is arranged repeatedly. The data signals of the same polarity are supplied to the data lines D4 and D5.

### 13th Arrangement Example

FIG. 18 shows the 13th arrangement example. In the 13th arrangement example, one block includes 2 columns×12 rows. Regarding a block surrounded by a dashed line in FIG. 18, a connection relationship between the liquid crystal cells in the 1st column and the data lines D1, D2 is as follows. The liquid crystal cells (1, R1), (1, G1), (1, B1), (1, R4), (1, G4) and (1, B4) are connected to the data line D1. The liquid crystal cells (1, R2), (1, G2), (1, B2), (1, R3), (1, G3) and (1, B3) are connected to the data line D2. A connection relationship between the liquid crystal cells in the 2nd column and the data lines D3, D4 is as follows. The liquid crystal cells (2, R1), (2, G1), (2, B1), (2, R4), (2, G4) and (2, B4) are connected to the data line D3. The liquid crystal cells (2, R2), (2, G2), (2, B2), (2, R3), (2, G3) and (2, B3) are connected to the data line D4.

A connection relationship between the liquid crystal cells in the 1st and 2nd columns and the scanning lines G1 to G12 is as follows. The liquid crystal cell (1, R1) and the liquid crystal cell (2, R1) are connected to the scanning line G1, the liquid crystal cell (1, G1) and the liquid crystal cell (2, G1) are connected to the scanning line G2, and the liquid crystal cell (1, B1) and the liquid crystal cell (2, B1) are connected to the scanning line G3. The liquid crystal cell (1, R2) and the liquid crystal cell (2, R2) are connected to the scanning line G4, the liquid crystal cell (1, G2) and the liquid crystal cell (2, G2) are connected to the scanning line G5, and the liquid crystal cell (1, B2) and the liquid crystal cell (2, B2) are connected to the scanning line G6. The liquid crystal cell (1, R3) and the liquid crystal cell (2, R3) are connected to the scanning line G7, the liquid crystal cell (1, G3) and the liquid crystal cell (2, G3) are connected to the scanning line G8, and the liquid crystal cell (1, B3) and the liquid crystal cell (2, B3) are connected to the scanning line G9. The liquid crystal cell (1, R4) and the liquid crystal cell (2, R4) are connected to the scanning line G10, the liquid crystal cell (1, G4) and the liquid crystal cell (2, G4) are connected to the scanning line G11, and the liquid crystal cell (1, B4) and the liquid crystal cell (2, B4) are connected to the scanning line G12.

Six successive scanning lines constitute one scanning group. Specifically, six successive scanning lines from the scanning line G1 to the scanning line G6 is referred to as a first scanning group. Six successive scanning lines from the scanning line G7 to the scanning line G12 is referred to as a second scanning group. Similarly, six successive scanning lines from the scanning line G(6i-5) to the scanning line G6i is referred to as i-th scanning group. Here, i is a natural number. When the liquid crystal display panel 2 has pixels corresponding to WXGA, i is a natural number not less than 1 and not more than 384.

The scanning order is shown at the right end of FIG. 18. In the 13th arrangement example, two scanning lines of the same color in one scanning group are selected concurrently. The scanning lines G1 and G4 associated with red color are driven in the first scanning period, the scanning lines G2 and G5 associated with green color are driven in the second scanning period, and the scanning lines G3 and G6 associated with blue color are driven in the third scanning period. The scanning lines G7 and G10 associated with red color are driven in the fourth scanning period, the scanning lines G8 and G11 associated with green color are driven in the fifth scanning period, and the scanning lines G9 and G12 associated with blue color are driven in the sixth scanning period. This scanning order is represented as “RR→GG→BB”, focusing on the color. In the 13th arrangement example, the dot inversion driving is employed, and the voltage polarity of the data line is inverted every one scanning period. By the way, pixel inversion driving is achieved by inverting the voltage polarity of the data line every three scanning periods.

In the six scanning periods when the block of 2 columns×12 rows surrounded by the dashed line is driven, the colors and the polarities of the data signals supplied to the liquid crystal cells (1, R1), (1, G1), (1, B1), (1, R4), (1, G4) and (1, B4) connected to the data line D1 are as follows. As shown, the data line driver circuit supplies the [R, positive]-signal, the [G, negative]-signal, the [B, positive]-signal, the [R, negative]-signal, the [G, positive]-signal and the [B, negative]-signal in this order to the data line D1. As for the liquid crystal cells (1, R2), (1, G2), (1, B2), (1, R3), (1, G3) and (1, B3) connected to the data line D2, the [R, negative]-signal, the [G, positive]-signal, the [B, negative]-signal, the [R, positive]-signal, the [G, negative]-signal and the [B, positive]-signal are respectively supplied in this order.

As for the liquid crystal cells (2, R1), (2, G1), (2, B1), (2, R4), (2, G4) and (2, B4) connected to the data line D3, the [R, negative]-signal, the [G, positive]-signal, the [B, negative]-signal, the [R, positive]-signal, the [G, negative]-signal and the [B, positive]-signal are respectively supplied in this order. As for the liquid crystal cells (2, R2), (2, G2), (2, B2), (2, R3), (2, G3) and (2, B3) connected to the data line D4, the [R, positive]-signal, the [G, negative]-signal, the [B, positive]-signal, the [R, negative]-signal, the [G, positive]-signal and the [B, negative]-signal are respectively supplied in this order.

In the above explanation, the scanning order is “RR→GG→BB”. The scanning order can also be “BB→GG→RR”, “BR→GG→RB”, “RB→GG→BR” and the like.

### 14th Arrangement Example

FIG. 19 shows the 14th arrangement example. Regarding a block surrounded by a dashed line in FIG. 19, a connection relationship between the liquid crystal cells in the 1st column and the data lines D1, D2 is as follows. The liquid crystal cells (1, R1), (1, B1), (1, G2), (1, G3), (1, R4) and (1, B4) are connected to the data line D1. The liquid crystal cells (1, G1), (1, R2), (1, B2), (1, R3), (1, B3) and (1, G4) are connected to the data line D2. A connection relationship between the liquid crystal cells in the 2nd column and the data lines D3, D4 is as follows. The liquid crystal cells (2, R1), (2, B1), (2, G2), (2, G3), (2, R4) and (2, B4) are connected to the data line D3. The liquid crystal cells (2, G1), (2, R2), (2, B2), (2, R3), (2, B3) and (2, G4) are connected to the data line D4.

A connection relationship between the liquid crystal cells in the 1st and 2nd columns and the scanning lines G1 to G12 is as follows. The liquid crystal cell (1, R1) and the liquid crystal cell (2, R1) are connected to the scanning line G1, the liquid crystal cell (1, G1) and the liquid crystal cell (2, G1) are connected to the scanning line G2, and the liquid crystal cell (1, B1) and the liquid crystal cell (2, B1) are connected to the scanning line G3. The liquid crystal cell (1, R2) and the liquid crystal cell (2, R2) are connected to the scanning line G4, the liquid crystal cell (1, G2) and the liquid crystal cell (2, G2) are connected to the scanning line G5, and the liquid crystal cell (1, B2) and the liquid crystal cell (2, B2) are connected to the scanning line G6. The liquid crystal cell (1, R3) and the liquid crystal cell (2, R3) are connected to the scanning line G7, the liquid crystal cell (1, G3) and the liquid crystal cell (2, G3) are connected to the scanning line G8, and the liquid crystal cell (1, B3) and the liquid crystal cell (2, B3) are connected to the scanning line G9. The liquid crystal cell (1, R4) and the liquid crystal cell (2, R4) are connected to the scanning line G10, the liquid crystal cell (1, G4) and the liquid crystal cell (2, G4) are connected to the scanning line G11, and the liquid crystal cell (1, B4) and the liquid crystal cell (2, B4) are connected to the scanning line G12.

The scanning order is shown at the right end of FIG. 19. In the 14th arrangement example, two scanning lines of the same color in one scanning group are selected concurrently. The scanning lines G1 and G4 associated with red color are driven in the first scanning period, the scanning lines G2 and G5 associated with green color are driven in the second scanning period, and the scanning lines G3 and G6 associated with blue color are driven in the third scanning period. The scanning lines G7 and G10 associated with red color are driven in the fourth scanning period, the scanning lines G8 and G11 associated with green color are driven in the fifth scanning period, and the scanning lines G9 and G12 associated with blue color are driven in the sixth scanning period. In the 14th arrangement example, the dot inversion driving is employed, and the voltage polarity of the data line is inverted every three scanning periods. By the way, pixel inversion driving is achieved by inverting the voltage polarity of the data line every one scanning period.

In the six scanning periods when the block of 2 columns×12 rows surrounded by the dashed line is driven, the colors and the polarities of the data signals supplied to the liquid crystal cells (1, R1), (1, B1), (1, G2), (1, G3), (1, R4) and (1, B4) connected to the data line D1 are as follows. As shown, the data line driver circuit supplies the [R, positive]-signal, the [B, positive]-signal, the [G, positive]-signal, the [G, negative]-signal, the [R, negative]-signal and the [B, negative]-signal in this order to the data line D1. As for the liquid crystal cells (1, G1), (1, R2), (1, B2), (1, R3), (1, B3) and (1, G4) connected to the data line D2, the [G, negative]-signal, the [R, negative]-signal, the [B, negative]-signal, the [R, positive]-signal, the [B, positive]-signal and the [G, positive]-signal are respectively supplied in this order.

As for the liquid crystal cells (2, R1), (2, B1), (2, G2), (2, G3), (2, R4) and (2, B4) connected to the data line D3, the [R, negative]-signal, the [B, negative]-signal, the [G, negative]-signal, the [G, positive]-signal, the [R, positive]-signal and the [B, positive]-signal are respectively supplied in this order. As for the liquid crystal cells (2, G1), (2, R2), (2, B2), (2, R3), (2, B3) and (2, G4) connected to the data line D4, the [G, positive]-signal, the [R, positive]-signal, the [B, positive]-signal, the [R, negative]-signal, the [B, negative]-signal and the [G, negative]-signal are respectively supplied in this order.

In the above explanation, the scanning order is “RR→GG→BB”. The scanning order can also be “BB→GG→RR”, “BR→GG→RB”, “RB→GG→BR” and the like.

### 15th Arrangement Example

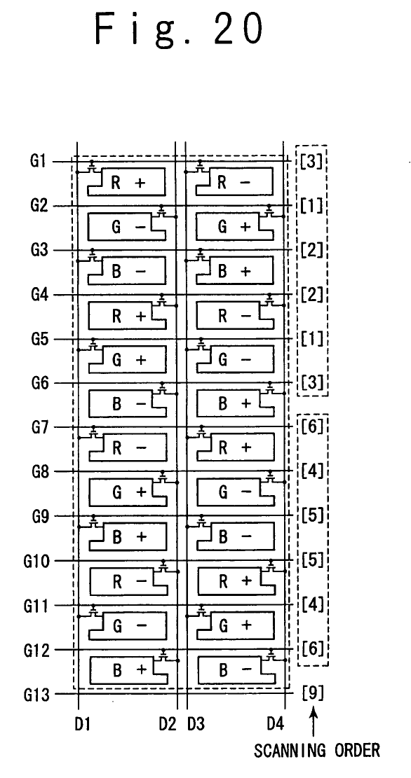

FIG. 20 shows the 15th arrangement example. Regarding a block surrounded by a dashed line in FIG. 20, a connection relationship between the liquid crystal cells in the 1st column and the data lines D1, D2 is as follows. The liquid crystal cells (1, R1), (1, B1), (1, G2), (1, R3), (1, B3) and (1, G4) are connected to the data line D1. The liquid crystal cells (1, G1), (1, R2), (1, B2), (1, G3), (1, R4) and (1, B4) are connected to the data line D2. A connection relationship between the liquid crystal cells in the 2nd column and the data lines D3, D4 is as follows. The liquid crystal cells (2, R1), (2, B1), (2, G2), (2, R3), (2, B3) and (2, G4) are connected to the data line D3. The liquid crystal cells (2, G1), (2, R2), (2, B2), (2, G3), (2, R4) and (2, B4) are connected to the data line D4.

A connection relationship between the liquid crystal cells in the 1st and 2nd columns and the scanning lines G1 to G12 is as follows. The liquid crystal cell (1, R1) and the liquid crystal cell (2, R1) are connected to the scanning line G1, the liquid crystal cell (1, G1) and the liquid crystal cell (2, G1) are connected to the scanning line G2, and the liquid crystal cell (1, B1) and the liquid crystal cell (2, B1) are connected to the scanning line G3. The liquid crystal cell (1, R2) and the liquid crystal cell (2, R2) are connected to the scanning line G4, the liquid crystal cell (1, G2) and the liquid crystal cell (2, G2) are connected to the scanning line G5, and the liquid crystal cell (1, B2) and the liquid crystal cell (2, B2) are connected to the scanning line G6. The liquid crystal cell (1, R3) and the liquid crystal cell (2, R3) are connected to the scanning line G7, the liquid crystal cell (1, G3) and the liquid crystal cell (2, G3) are connected to the scanning line G8, and the liquid crystal cell (1, B3) and the liquid crystal cell (2, B3) are connected to the scanning line G9. The liquid crystal cell (1, R4) and the liquid crystal cell (2, R4) are connected to the scanning line G10, the liquid crystal cell (1, G4) and the liquid crystal cell (2, G4) are connected to the scanning line G11, and the liquid crystal cell (1, B4) and the liquid crystal cell (2, B4) are connected to the scanning line G12.

The scanning order is shown at the right end of FIG. 20. In the 15th arrangement example, the scanning line selection is as follows. As for the green color having high luminosity, two scanning lines of green color in one scanning group are selected concurrently. However, as for the red color and the blue color, one scanning line of blue color and one scanning line of red color are selected concurrently. The scanning lines G2 and G5 associated with green color are concurrently driven in the first scanning period. The scanning line G3 associated with blue color and the scanning line G4 associated with red color are concurrently driven in the second scanning period. The scanning line G1 associated with red color and the scanning line G6 associated with blue color are concurrently driven in the third scanning period. The scanning lines G8 and G11 associated with green color are concurrently driven in the fourth scanning period. The scanning line G9 associated with blue color and the scanning line G10 associated with red color are concurrently driven in the fifth scanning period. The scanning line G7 associated with red color and the scanning line G12 associated with blue color are concurrently driven in the sixth scanning period. This scanning order is represented as “GG→BR→RB”, focusing on the color. In the 15th arrangement example, the 2H1V (H: horizontal, V: vertical) dot inversion pattern is achieved, and the voltage polarity of the data line is inverted every one scanning period.

In the six scanning periods when the block of 2 columns×12 rows surrounded by the dashed line is driven, the colors and the polarities of the data signals supplied to the liquid crystal cells (1, G2), (1, B1), (1, R1), (1, G4), (1, B3) and (1, R3) connected to the data line D1 are as follows. As shown, the data line driver circuit supplies the [G, positive]-signal, the [B, negative]-signal, the [R, positive]-signal, the [G, negative]-signal, the [B, positive]-signal and the [R, negative]-signal in this order to the data line D1. As for the liquid crystal cells (1, G1), (1, R2), (1, B2), (1, G3), (1, R4) and (1, B4) connected to the data line D2, the [G, negative]-signal, the [R, positive]-signal, the [B, negative]-signal, the [G, positive]-signal, the [R, negative]-signal and the [B, positive]-signal are respectively supplied in this order.

As for the liquid crystal cells (2, G2), (2, B1), (2, R1), (2, G4), (2, B3) and (2, R3) connected to the data line D3, the [G, negative]-signal, the [B, positive]-signal, the [R, negative]-signal, the [G, positive]-signal, the [B, negative]-signal and the [R, positive]-signal are respectively supplied in this order. As for the liquid crystal cells (2, G1), (2, R2), (2, B2), (2, G3), (2, R4) and (2, B4) connected to the data line D4, the [G, positive]-signal, the [R, negative]-signal, the [B, positive]-signal, the [G, negative]-signal, the [R, positive]-signal and the [B, negative]-signal are respectively supplied in this order.

In the above explanation, the scanning order is “GG→BR→RB”. The scanning order can also be the opposite (“RB→BR→GG”) and the like.

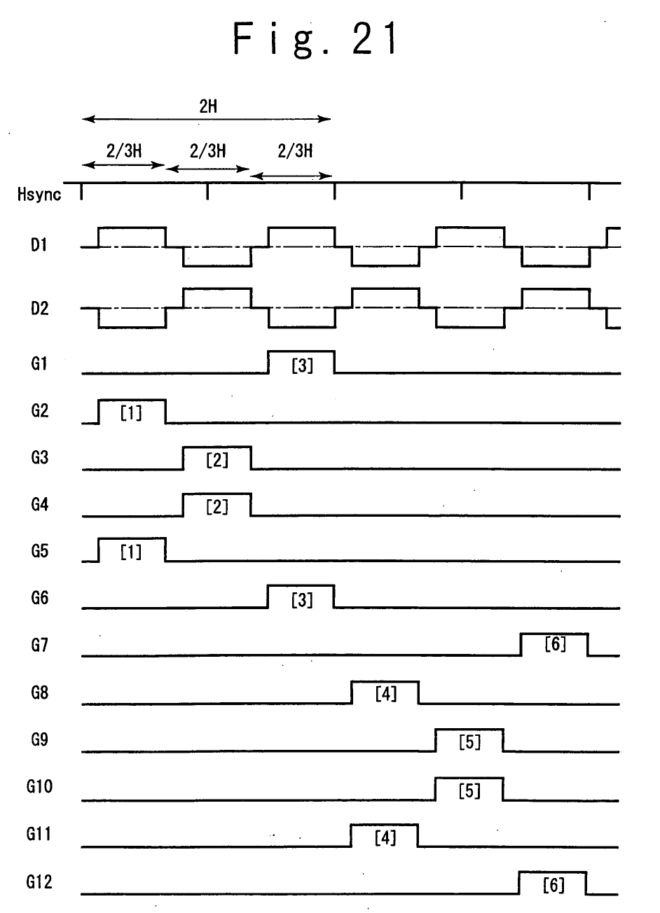

An operation of the 15th arrangement example will be described below with reference to a timing chart shown in FIG. 21. In FIG. 21, a horizontal synchronizing signal Hsync is a control signal for synchronizing every one horizontal period, and two-thirds of one horizontal period is equal to one scanning period (1 G=⅔ H). The data signals D1 and D2 are analog signals output from the data line driver circuit. The scanning signals G1 to G6 are digital signals output from the scanning line driver circuit.

As shown in FIG. 21, in the first scanning period, the scanning lines G2 and G5 are driven and the scanning signals G2 and G5 are turned ON. The [G, positive]-signal is supplied to the data line D1, and the [G, negative]-signal is supplied to the data line D2. In the second scanning period, the scanning lines G3 and G4 are driven and the scanning signals G3 and G4 are turned ON. The [B, negative]-signal is supplied to the data line D1, and the [R, positive]-signal is supplied to the data line D2. In the third scanning period, the scanning lines G1 and G6 are driven and the scanning signals G1 and G6 are turned ON. The [R, positive]-signal is supplied to the data line D1, and the [B, negative]-signal is supplied to the data line D2.

In the fourth scanning period, the scanning lines G8 and G11 are driven and the scanning signals G8 and G11 are turned ON. The [G, negative]-signal is supplied to the data line D1, and the [G, positive]-signal is supplied to the data line D2. In the fifth scanning period, the scanning lines G9 and G10 are driven and the scanning signals G9 and G10 are turned ON. The [B, positive]-signal is supplied to the data line D1, and the [R, negative]-signal is supplied to the data line D2. In the sixth scanning period, the scanning lines G7 and G12 are driven and the scanning signals G7 and G12 are turned ON. The [R, negative]-signal is supplied to the data line D1, and the [B, positive]-signal is supplied to the data line D2.

### 16th Arrangement Example

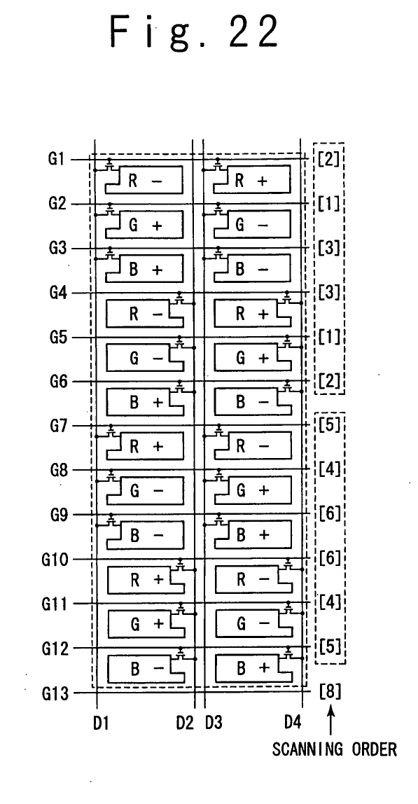

FIG. 22 shows the 16th arrangement example. Regarding a block surrounded by a dashed line in FIG. 22, a connection relationship between the liquid crystal cells in the 1st column and the data lines D1, D2 is as follows. The liquid crystal cells (1, R1), (1, G1), (1, B1), (1, R3), (1, G3) and (1, B3) are connected to the data line D1. The liquid crystal cells (1, R2), (1, G2), (1, B2), (1, R4), (1, G4) and (1, B4) are connected to the data line D2. A connection relationship between the liquid crystal cells in the 2nd column and the data lines D3, D4 is as follows. The liquid crystal cells (2, R1), (2, G1), (2, B1), (2, R3), (2, G3) and (2, B3) are connected to the data line D3. The liquid crystal cells (2, R2), (2, G2), (2, B2), (2, R4), (2, G4) and (2, B4) are connected to the data line D4.

A connection relationship between the liquid crystal cells in the 1st and 2nd columns and the scanning lines G1 to G12 is as follows. The liquid crystal cell (1, R1) and the liquid crystal cell (2, R1) are connected to the scanning line G1, the liquid crystal cell (1, G1) and the liquid crystal cell (2, G1) are connected to the scanning line G2, and the liquid crystal cell (1, B1) and the liquid crystal cell (2, B1) are connected to the scanning line G3. The liquid crystal cell (1, R2) and the liquid crystal cell (2, R2) are connected to the scanning line G4, the liquid crystal cell (1, G2) and the liquid crystal cell (2, G2) are connected to the scanning line G5, and the liquid crystal cell (1, B2) and the liquid crystal cell (2, B2) are connected to the scanning line G6. The liquid crystal cell (1, R3) and the liquid crystal cell (2, R3) are connected to the scanning line G7, the liquid crystal cell (1, G3) and the liquid crystal cell (2, G3) are connected to the scanning line G8, and the liquid crystal cell (1, B3) and the liquid crystal cell (2, B3) are connected to the scanning line G9. The liquid crystal cell (1, R4) and the liquid crystal cell (2, R4) are connected to the scanning line G10, the liquid crystal cell (1, G4) and the liquid crystal cell (2, G4) are connected to the scanning line G11, and the liquid crystal cell (1, B4) and the liquid crystal cell (2, B4) are connected to the scanning line G12.

The scanning order is shown at the right end of FIG. 22. In the 16th arrangement example, the scanning line selection is as follows. As for the green color having high luminosity, two scanning lines of green color in one scanning group are selected concurrently. However, as for the red color and the blue color, one scanning line of blue color and one scanning line of red color are selected concurrently. The scanning lines G2 and G5 associated with green color are concurrently driven in the first scanning period. The scanning line G1 associated with red color and the scanning line G6 associated with blue color are concurrently driven in the second scanning period. The scanning line G3 associated with blue color and the scanning line G4 associated with red color are concurrently driven in the third scanning period. The scanning lines G8 and G11 associated with green color are concurrently driven in the fourth scanning period. The scanning line G7 associated with red color and the scanning line G12 associated with blue color are concurrently driven in the fifth scanning period. The scanning line G9 associated with blue color and the scanning line G10 associated with red color are concurrently driven in the sixth scanning period. In the 16th arrangement example, the 2H1V dot inversion pattern is achieved, and the voltage polarity of the data line is inverted every one scanning period.

In the six scanning periods when the block of 2 columns×12 rows surrounded by the dashed line is driven, the colors and the polarities of the data signals supplied to the liquid crystal cells (1, G1), (1, R1), (1, B1), (1, G3), (1, R3) and (1, B3) connected to the data line D1 are as follows. As shown, the data line driver circuit supplies the [G, positive]-signal, the [R, negative]-signal, the [B, positive]-signal, the [G, negative]-signal, the [R, positive]-signal and the [B, negative]-signal in this order to the data line D1. As for the liquid crystal cells (1, G2), (1, B2), (1, R2), (1, G4), (1, B4) and (1, R4) connected to the data line D2, the [G, negative]-signal, the [B, positive]-signal, the [R, negative]-signal, the [G, positive]-signal, the [B, negative]-signal and the [R, positive]-signal are respectively supplied in this order.

As for the liquid crystal cells (2, G1), (2, R1), (2, B1), (2, G3), (2, R3) and (2, B3) connected to the data line D3, the [G, negative]-signal, the [R, positive]-signal, the [B, negative]-signal, the [G, positive]-signal, the [R, negative]-signal and the [B, positive]-signal are respectively supplied in this order. As for the liquid crystal cells (2, G2), (2, B2), (2, R2), (2, G4), (2, B4) and (2, R4) connected to the data line D4, the [G, positive]-signal, the [B, negative]-signal, the [R, positive]-signal, the [G, negative]-signal, the [B, positive]-signal and the [R, negative]-signal are respectively supplied in this order.

In the above explanation, the scanning order is “GG→RB→BR”. The scanning order can also be the opposite (“BR→RB→GG”) and the like.

### 17th Arrangement Example

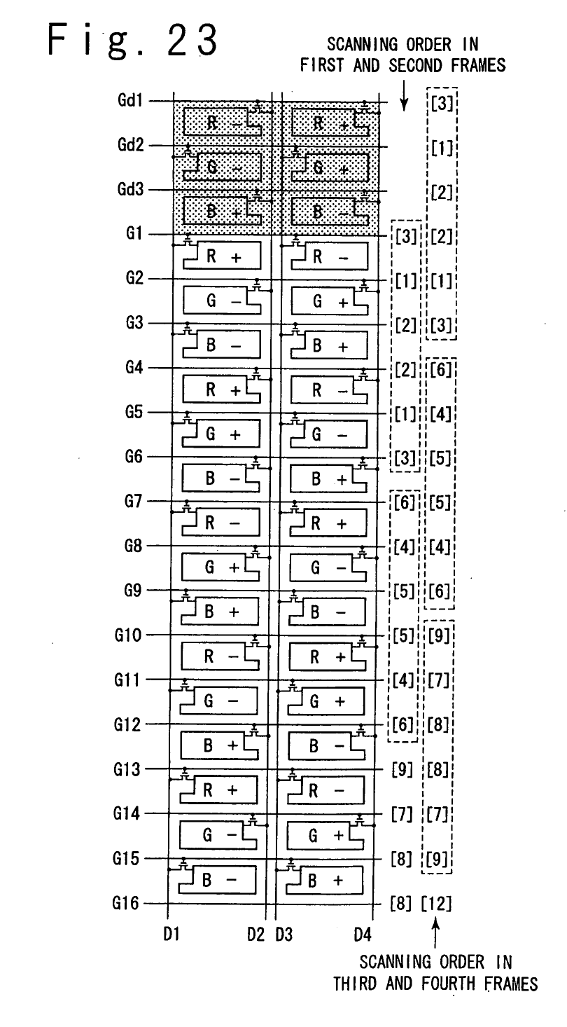

FIG. 23 shows the 17th arrangement example. The 17th arrangement example is a modification example of the 15th and 16th arrangement examples. In the 17th arrangement example, one block includes 2 columns×12 rows as well. A connection relationship between the liquid crystal cells in the 1st column and the data lines D1, D2 is as follows. The liquid crystal cells (1, R1), (1, B1), (1, G2), (1, R3), (1, B3) and (1, G4) and a dummy liquid crystal cell (1, G0) are connected to the data line D1. The liquid crystal cells (1, G1), (1, R2), (1, B2), (1, G3), (1, R4) and (1, B4) and dummy liquid crystal cells (1, R0) and (1, B0) are connected to the data line D2. A connection relationship between the liquid crystal cells in the 2nd column and the data lines D3, D4 is as follows. The liquid crystal cells (2, R1), (2, B1), (2, G2), (2, R3), (2, B3) and (2, G4) and a dummy liquid crystal cell (2, G0) are connected to the data line D3. The liquid crystal cells (2, G1), (2, R2), (2, B2), (2, G3), (2, R4) and (2, B4) and dummy liquid crystal cells (2, R0) and (2, B0) are connected to the data line D4.

A connection relationship between the liquid crystal cells in the 1st and 2nd columns and the scanning lines G1 to G12 is as follows. The liquid crystal cell (1, R1) and the liquid crystal cell (2, R1) are connected to the scanning line G1, the liquid crystal cell (1, G1) and the liquid crystal cell (2, G1) are connected to the scanning line G2, and the liquid crystal cell (1, B1) and the liquid crystal cell (2, B1) are connected to the scanning line G3. The liquid crystal cell (1, R2) and the liquid crystal cell (2, R2) are connected to the scanning line G4, the liquid crystal cell (1, G2) and the liquid crystal cell (2, G2) are connected to the scanning line G5, and the liquid crystal cell (1, B2) and the liquid crystal cell (2, B2) are connected to the scanning line G6. The liquid crystal cell (1, R3) and the liquid crystal cell (2, R3) are connected to the scanning line G7, the liquid crystal cell (1, G3) and the liquid crystal cell (2, G3) are connected to the scanning line G8, and the liquid crystal cell (1, B3) and the liquid crystal cell (2, B3) are connected to the scanning line G9. The liquid crystal cell (1, R4) and the liquid crystal cell (2, R4) are connected to the scanning line G10, the liquid crystal cell (1, G4) and the liquid crystal cell (2, G4) are connected to the scanning line G11, and the liquid crystal cell (1, B4) and the liquid crystal cell (2, B4) are connected to the scanning line G12. The dummy liquid crystal cell (1, R0) and the dummy liquid crystal cell (2, R0) are connected to a dummy scanning line Gd1. The dummy liquid crystal cell (1, G0) and the dummy liquid crystal cell (2, G0) are connected to a dummy scanning line Gd2. The dummy liquid crystal cell (1, B0) and the dummy liquid crystal cell (2, B0) are connected to a dummy scanning line Gd3.

The scanning order is shown at the right end of FIG. 23. In the 17th arrangement example, a combination of the scanning lines concurrently selected is changed every two frames. That is to say, the scanning order in the first and second frames is different from that in the third and fourth frames. In the first and second frames, the scanning lines G2 and G5 are driven in the first scanning period, the scanning lines G3 and G4 are driven in the second scanning period, and the scanning lines G1 and G6 are driven in the third scanning period. Moreover, the scanning lines G8 and G11 are driven in the fourth scanning period, the scanning lines G9 and G10 are driven in the fifth scanning period, and the scanning lines G7 and G12 are driven in the sixth scanning period. On the other hand, in the third and fourth frames, the scanning lines Gd2 and G2 are driven in the first scanning period, the scanning lines Gd3 and G1 are driven in the second scanning period, and the scanning lines Gd1 and G3 are driven in the third scanning period. Moreover, the scanning lines G5 and G8 are driven in the fourth scanning period, the scanning lines G6 and G7 are driven in the fifth scanning period, and the scanning lines G4 and G9 are driven in the sixth scanning period. Moreover, the scanning lines G11 and G14 are driven in the seventh scanning period, the scanning lines G12 and G13 are driven in the eighth scanning period, and the scanning lines G0 and G15 are driven in the ninth scanning period.

Regarding the first frame and in a period from the first to sixth scanning periods when the block of 2 columns×12 rows is driven, the colors and the polarities of the data signals supplied to the liquid crystal cells (1, G2), (1, B1), (1, R1), (1, G4), (1, B3) and (1, R3) connected to the data line D1 are as follows. As shown, the data line driver circuit supplies the [G, positive]-signal, the [B, negative]-signal, the [R, positive]-signal, the [G, negative]-signal, the [B, positive]-signal and the [R, negative]-signal in this order to the data line D1. As for the liquid crystal cells (1, G1), (1, R2), (1, B2), (1, G3), (1, R4) and (1, B4) connected to the data line D2, the [G, negative]-signal, the [R, positive]-signal, the [B, negative]-signal, the [G, positive]-signal, the [R, negative]-signal and the [B, positive]-signal are respectively supplied in this order. In the second frame, all the voltage polarities are inverted as compared with the first frame.

Regarding the third frame and in a period from the first to ninth scanning periods, the colors and the polarities of the data signals supplied to the liquid crystal cells (1, G0), (1, R1), (1, B1), (1, G2), (1, R3), (1, B3), (1, G4), (1, R5) and (1, B5) connected to the data line D1 are as follows. As shown, the data line driver circuit supplies the [G, negative]-signal, the [R, positive]-signal, the [B, negative]-signal, the [G, positive]-signal, the [R, negative]-signal, the [B, positive]-signal, the [G, negative]-signal, the [R, positive]-signal and the [B, negative]-signal in this order to the data line D1. As for the liquid crystal cells (1, G1), (1, B0), (1, R0), (1, G3), (1, B2), (1, R2), (1, G5), (1, B4) and (1, R4) connected to the data line D2, the [G, negative]-signal, the [B, positive]-signal, the [R, negative]-signal, the [G, positive]-signal, the [B, negative]-signal, the [R, positive]-signal, the [G, negative]-signal, the [B, positive]-signal and the [R, negative]-signal are respectively supplied in this order. In the fourth frame, all the voltage polarities are inverted as compared with the third frame.

Regarding the first frame and in the period from the first to sixth scanning periods, the colors and the polarities of the data signals supplied to the liquid crystal cells (2, G2), (2, B1), (2, R1), (2, G4), (2, B3) and (2, R3) connected to the data line D3 are as follows. As shown, the data line driver circuit supplies the [G, negative]-signal, the [B, positive]-signal, the [R, negative]-signal, the [G, positive]-signal, the [B, negative]-signal and the [R, positive]-signal in this order to the data line D1. As for the liquid crystal cells (2, G1), (2, R2), (2, B2), (2, G3), (2, R4) and (2, B4) connected to the data line D4, the [G, positive]-signal, the [R, negative]-signal, the [B, positive]-signal, the [G, negative]-signal, the [R, positive]-signal and the [B, negative]-signal are respectively supplied in this order. In the second frame, all the voltage polarities are inverted as compared with the first frame.

Regarding the third frame and in the period from the first to ninth scanning periods, the colors and the polarities of the data signals supplied to the liquid crystal cells (2, G0), (2, R1), (2, B1), (2, G2), (2, R3), (2, B3), (2, G4), (2, R5) and (2, B5) connected to the data line D3 are as follows. As shown, the data line driver circuit supplies the [G, positive]-signal, the [R, negative]-signal, the [B, positive]-signal, the [G, negative]-signal, the [R, positive]-signal, the [B, negative]-signal, the [G, positive]-signal, the [R, negative]-signal and the [B, positive]-signal in this order to the data line D1. As for the liquid crystal cells (2, G1), (2, B0), (2, R0), (2, G3), (2, B2), (2, R2), (2, G5), (2, B4) and (2, R4) connected to the data line D4, the [G, positive]-signal, the [B, negative]-signal, the [R, positive]-signal, the [G, negative]-signal, the [B, positive]-signal, the [R, negative]-signal, the [G, positive]-signal, the [B, negative]-signal and the [R, positive]-signal are respectively supplied in this order. In the fourth frame, all the voltage polarities are inverted as compared with the third frame.

### 18th Arrangement Example

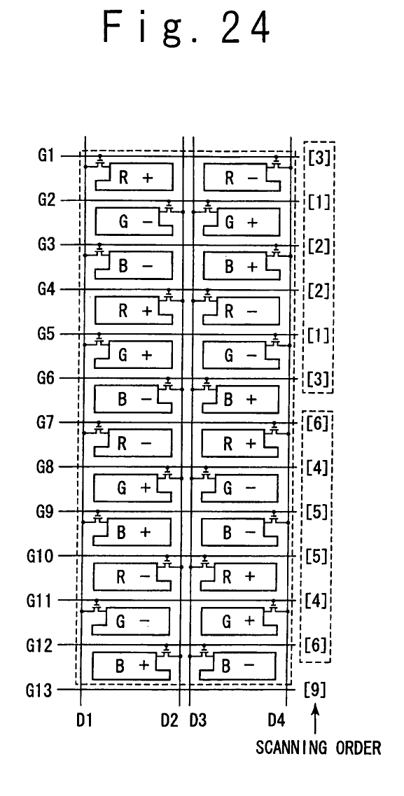

FIG. 24 shows the 18th arrangement example. The 18th arrangement example is a modification example of the 15th arrangement example, which is obtained by mirror-inverting the 2nd column with respect to a center line between the data lines D3 and D4 as the inversion axis. The 18th arrangement example is different in the TFT position from the 15th arrangement example. Regarding a block surrounded by a dashed line in FIG. 24, a connection relationship between the liquid crystal cells in the 1st column and the data lines D1, D2 is as follows. The liquid crystal cells (1, R1), (1, B1), (1, G2), (1, R3), (1, B3) and (1, G4) are connected to the data line D1. The liquid crystal cells (1, G1), (1, R2), (1, B2), (1, G3), (1, R4) and (1, B4) are connected to the data line D2. A connection relationship between the liquid crystal cells in the 2nd column and the data lines D3, D4 is as follows. The liquid crystal cells (2, G1), (2, R2), (2, B2), (2, G3), (2, R4) and (2, B4) are connected to the data line D3. The liquid crystal cells (2, R1), (2, B1), (2, G2), (2, R3), (2, B3) and (2, G4) are connected to the data line D4.

A connection relationship between the liquid crystal cells in the 1st and 2nd columns and the scanning lines G1 to G12 is as follows. The liquid crystal cell (1, R1) and the liquid crystal cell (2, R1) are connected to the scanning line G1, the liquid crystal cell (1, G1) and the liquid crystal cell (2, G1) are connected to the scanning line G2, and the liquid crystal cell (1, B1) and the liquid crystal cell (2, B1) are connected to the scanning line G3. The liquid crystal cell (1, R2) and the liquid crystal cell (2, R2) are connected to the scanning line G4, the liquid crystal cell (1, G2) and the liquid crystal cell (2, G2) are connected to the scanning line G5, and the liquid crystal cell (1, B2) and the liquid crystal cell (2, B2) are connected to the scanning line G6. The liquid crystal cell (1, R3) and the liquid crystal cell (2, R3) are connected to the scanning line G7, the liquid crystal cell (1, G3) and the liquid crystal cell (2, G3) are connected to the scanning line G8, and the liquid crystal cell (1, B3) and the liquid crystal cell (2, B3) are connected to the scanning line G9. The liquid crystal cell (1, R4) and the liquid crystal cell (2, R4) are connected to the scanning line G10, the liquid crystal cell (1, G4) and the liquid crystal cell (2, G4) are connected to the scanning line G11, and the liquid crystal cell (1, B4) and the liquid crystal cell (2, B4) are connected to the scanning line G12.

The scanning order is shown at the right end of FIG. 24. In the 18th arrangement example, the scanning line selection is as follows. As for the green color having high luminosity, two scanning lines of green color in one scanning group are selected concurrently. However, as for the red color and the blue color, one scanning line of blue color and one scanning line of red color are selected concurrently. The scanning lines G2 and G5 associated with green color are concurrently driven in the first scanning period. The scanning line G3 associated with blue color and the scanning line G4 associated with red color are concurrently driven in the second scanning period. The scanning line G1 associated with red color and the scanning line G6 associated with blue color are concurrently driven in the third scanning period. The scanning lines G8 and G11 associated with green color are concurrently driven in the fourth scanning period. The scanning line G9 associated with blue color and the scanning line G10 associated with red color are concurrently driven in the fifth scanning period. The scanning line G7 associated with red color and the scanning line G12 associated with blue color are concurrently driven in the sixth scanning period. In the 18th arrangement example, the 2H1V dot inversion pattern is achieved.

In the six scanning periods when the block of 2 columns×12 rows surrounded by the dashed line is driven, the colors and the polarities of the data signals supplied to the liquid crystal cells (1, G2), (1, B1), (1, R1), (1, G4), (1, B3) and (1, R3) connected to the data line D1 are as follows. As shown, the data line driver circuit supplies the [G, positive]-signal, the [B, negative]-signal, the [R, positive]-signal, the [G, negative]-signal, the [B, positive]-signal and the [R, negative]-signal in this order to the data line D1. As for the liquid crystal cells (1, G1), (1, R2), (1, B2), (1, G3), (1, R4) and (1, B4) connected to the data line D2, the [G, negative]-signal, the [R, positive]-signal, the [B, negative]-signal, the [G, positive]-signal, the [R, negative]-signal and the [B, positive]-signal are respectively supplied in this order.

As for the liquid crystal cells (2, G1), (2, R2), (2, B2), (2, G3), (2, R4) and (2, B4) connected to the data line D3, the [G, positive]-signal, the [R, negative]-signal, the [B, positive]-signal, the [G, negative]-signal, the [R, positive]-signal and the [B, negative]-signal are respectively supplied in this order. As for the liquid crystal cells (2, G2), (2, B1), (2, R1), (2, G4), (2, B3) and (2, R3) connected to the data line D4, the [G, negative]-signal, the [B, positive]-signal, the [R, negative]-signal, the [G, positive]-signal, the [B, negative]-signal and the [R, positive]-signal are respectively supplied in this order.

As in the case of the 18th arrangement example, an arrangement example obtained by mirror-inverting the 13th arrangement example, an arrangement example obtained by mirror-inverting the 14th arrangement example, an arrangement example obtained by mirror-inverting the 16th arrangement example and the like are also possible.

It is apparent that the present invention is not limited to the above embodiments and may be modified and changed without departing from the scope and spirit of the invention.

What is claimed is:

1. A liquid crystal display device comprising:
a liquid crystal panel having liquid crystal cells that are arranged in a matrix form at respective intersections of a plurality of data lines and a plurality of scanning lines; and
a data line driver circuit configured to supply data signals to said plurality of data lines,
wherein said data signals include six kinds of data signals comprising:
a first data signal of positive polarity associated with a first color image data;
a second data signal of negative polarity associated with said first color image data;
a third data signal of positive polarity associated with a second color image data;
a fourth data signal of negative polarity associated with said second color image data;
a fifth data signal of positive polarity associated with a third color image data; and
a sixth data signal of negative polarity associated with said third color image data,
wherein said data line driver circuit switches said six kinds of data signals and supplies each of said six kinds of data signals for a same number of times during a predetermined period with respect to each of said plurality of data lines.

2. The liquid crystal display device according to claim 1,
wherein n is a natural number, a number of said liquid crystal cells in a first direction is n, and a number of at least any of said plurality of data lines and said plurality of scanning lines is 2n.

3. The liquid crystal display device according to claim 2,
wherein said first direction is a vertical direction, a number of said plurality of scanning lines is 2n, and a color arrangement is a vertical stripe arrangement.

4. The liquid crystal display device according to claim 3,
wherein two adjacent liquid crystal cells arranged between two adjacent data lines among said plurality of data lines are connected to a same scanning line.

5. The liquid crystal display device according to claim 4,
wherein voltage polarity of the data signal supplied to said each data line is inverted every one scanning period.

6. The liquid crystal display device according to claim 5,
wherein said liquid crystal panel further has dummy liquid crystal cells that are shaded,
wherein said number of liquid crystal cells in said first direction is a number of effective liquid crystal cells other than said dummy liquid crystal cells, and a number of said effective liquid crystal cells in said first direction is said n.

7. The liquid crystal display device according to claim 2,
wherein said first direction is a vertical direction, a number of said plurality of scanning lines is 2n, and a four color arrangement is 2×2 arrangement.

8. The liquid crystal display device according to claim 7,
wherein said data signals include eight kinds of data signals comprising:
said first to sixth data signals;
a seventh data signal of positive polarity associated with a fourth color image data; and
a eighth data signal of negative polarity associated with said fourth color image data,
wherein said data line driver circuit switches said eight kinds of data signals and supplies each of said eight kinds of data signals for a same number of times during a predetermined period with respect to each of said plurality of data lines.

9. The liquid crystal display device according to claim 2,
wherein said first direction is a horizontal direction, a number of said plurality of data lines is 2n, and a color arrangement is a horizontal stripe arrangement.

10. A method of driving a liquid crystal display device, comprising:
supplying each of six kinds of data signals for a same number of times during a first predetermined period, with respect to one data line,
wherein said six kinds of data signals include:
a first data signal of positive polarity associated with a first color image data;
a second data signal of negative polarity associated with said first color image data;
a third data signal of positive polarity associated with a second color image data;
a fourth data signal of negative polarity associated with said second color image data;
a fifth data signal of positive polarity associated with a third color image data; and
a sixth data signal of negative polarity associated with said third color image data; and
supplying each of said six kinds of data signals for the same number of times during a second predetermined period whose length is equal to that of said first predetermined period, with respect to said one data line.
